(19) United States
(12) Patent Application Publication
(10) Pub. No.: US 2018/0085763 A1
(43) Pub. Date: Mar. 29, 2018

(54) Electronic Nozzle

(71) Applicant: Erik Leckner, Fallbrook, CA (US)

(72) Inventor: Erik Leckner, Fallbrook, CA (US)

(21) Appl. No.: 15/276,874

(22) Filed: Sep. 27, 2016

(51) Int. Cl. B05B 1/30; B05B 1/34; B05B 1/04; B05B 9/01

(52) U.S. Cl. CPC B05B 1/30; B05B 9/01; B05B 1/04; B05B 1/34

(57) ABSTRACT

The invention relates to an electronically operated nozzle having at least one electric motor that can control the adjustment and operation of the nozzle by means of on-board electronics on a nozzle body and a communications module. The electronic nozzle consists of a nozzle body and a detachable nozzle head that is electromechanically operated by at least one drive mechanism. Between the nozzle body and the nozzle head is situated at least one electric motor and drive assembly that adjust the settings of the nozzle for fluid entering or exiting the nozzle and control the operation of flow. The invention provides for the creation of electromechanical mechanisms that are easy to manufacture and has components that enable the electronic nozzle to be adjusted and operated with little to no mechanical movement by an operator. The invention also provides for electromechanical mechanisms and tools that can be adapted to marketplace nozzles.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### REFERENCE TO PENDING APPLICATIONS

This application is not based upon any pending domestic or international patent application.

### FIELD OF THE INVENTION

This invention relates to adjustable nozzles for fluid systems, and more particularly to electromechanically adjusted and operated nozzles for fluid systems. This invention also relates to adapters and tools for fluid devices, and more particularly to electromechanically operated adapters and tools for the adjustment and operation of fluid devices.

### BACKGROUND OF THE INVENTION

Today, there are a multitude of adjustable fluid dispensing devices available. This includes water garden hose nozzles, water faucet nozzles, shower head nozzles, turret pistols, adjustable pistols, fireman nozzles, sprinklers, drip emitters, oscillators, wands, and other hose attachment fluid dispensing devices. Common to all of these devices is an adjustable valved nozzle that provides mechanical mechanisms for adjusting the character of the discharging stream. Adjustments which can be made to the nozzle typically include one or more of the following: adjustable arc, spray elevation angle, flow rate, distance or radius, pattern, nozzle opening, control valve opening, and so forth.

The simplest of these nozzles are merely adjustable by depressing or pulling the handle, trigger or by rotating a mechanical knob and the operator is required to manually maintain the trigger at a desired position for a period of time. Any deviation from this position alters or changes the character of the spray. For this reason it is virtually impossible for an operator to manually maintain any intermediate spray position between the two extreme limits in the simplest of these nozzles, i.e. the open and closed positions of the nozzle, for any given length of time. Even in nozzles which provide for fixed spray adjustments, it is virtually impossible to maintain a spray variation which falls intermediate the adjusted position and the extreme limit of such nozzle. Most handheld nozzles, wands, sprinklers, oscillators, and drip emitters today provide mechanisms for fixing and maintaining a plurality of spray positions or variations which lie intermediate the extreme limits or setting of a nozzle. Some of these nozzles, provide a means for finely varying the character of spray in any of the fixed positions. Some also have a one hand operational design where operators can control the settings mechanically while the nozzle is in operation, but most require a two hand operational/adjustment design. All of the nozzles today are fixed in their features when purchased, relatively simple in their construction, easy to manufacture, and serve a fixed set of purposes, and require manual mechanical adjustments.

A typical nozzle, sprinkler, oscillator, and the like has one or two inlet connections, one of which is connected to the end of a garden hose or the like that serves as a supply of water under pressure to the sprayer and the second of which is connected to a separate product container to be selectively dispensed from the nozzle. Nozzles of this type are often used in the home garden or yard with the flow of water passing through the nozzles.

The nozzle provides features that enhance its usefulness without detracting from the ease of operating the nozzle. In many hose end nozzles that have several useful features, for example, a control valve that has the options of stopping the flow of water through the nozzle, or opening the flow of water through the nozzle, the control valve that is simple to operate requires additional component parts for the nozzle which may eventually leak, or the control valve that has a reduced number of component parts becomes more and difficult to operate. Increasing the component parts of the sprayer nozzle, sprinkler, oscillator, drip emitter and the like increases its cost, making it unattractive to the average residential consumer, especially when multiple nozzles are desired for different tasks, such as washing the car, watering the garden, irrigating a lawn—this is why manufacturers also offer consumers a set of nozzles, sprayers, sprinkler heads, drip emitters, and/or wand-shaped nozzles. In addition, nozzles that are more advanced but constructed inexpensively tend to be more difficult to operate, and although reduced in cost, are not as attractive to consumers for everyday use.

Common to most irrigation nozzles, such as sprinklers, oscillators, and drip emitters, is an adjustable valved nozzle that provides simple to complex mechanical mechanisms for adjusting the character of the discharging stream. For example, for a sprinkler head adjustment during installation, one must perform the following actions in order to adjust the sprinkler head sold in home improvement stores across the world: “First insert a plastic key end of the wrench into the lifting socket of the sprinkler and turn 90°. Pull the riser up to gain access to the nozzle socket. Using the steel hex key of the wrench, turn the radius adjustment screw counterclockwise to be sure it is not blocking the nozzle socket opening. If a nozzle is already installed, it can be removed by backing out the adjustment screw and turning on the water, or by pulling outward on the nozzle ears with a pair of needle-nosed pliers. Slip the desired nozzle into the nozzle socket. The ears should be adjusted so that the nozzle range screw threads directly down between them. Tighten the nozzle range screw. The raised bump with an arrow on the rubber cover will always indicate the location of the nozzle and direction of water flow when the sprinkler is retracted. If the right side of the arc is not properly aligned, the results may be a wet walkway or a dry turf area. The right side arc can easily be realigned. One way to realign the right stop is to turn the whole sprinkler body assembly and the fitting below it, left or right to the desired position. This may require temporary removal of the soil around the sprinkler to allow you to grip the sprinkler housing. Another way to reset the right arc is to unscrew the body cap counterclockwise and remove the internal assembly from the body. Once removed, rotate the nozzle turret to the right stop, screw the internal assembly back into the body with the nozzle aligned to the right side of the area you want irrigated. At this point you have realigned the right arc stop, and you can adjust the left arc to an appropriate setting.”

In addition to adjustment complexity, there are numerous types of sprinklers. Sprinklers that spray in a fixed pattern are generally called sprays or spray heads. Higher pressure sprinklers that themselves move in a circle are driven by a ball drive, gear drive, or impact mechanism, e.g. impact sprinklers. These can be designed to rotate in a full or partial circle. Rainguns are similar to impact sprinklers, except that they generally operate at very high pressures. An oscillating sprinkler is commonly used to water smaller residential lawns, and is moved as needed. Home lawn sprinklers vary widely in their size, cost, and complexity. They include impact sprinklers as described above, oscillating sprinklers, drip emitters, and underground sprinkler systems. Small sprinklers are available at home and garden stores or hardware stores for small costs. These are often attached to an outdoor water faucet and are placed only temporarily. Other systems may be professionally installed permanently in the ground and are attached permanently to a home's plumbing system. Permanently installed systems may often operate on timers or other automated processes. They are occasionally installed with retractable heads for aesthetic and practical reasons (making damage during lawn mowing or other maintenance less likely—however, damages may still occur at night). These often are programmed to operate at certain times of day or on some other schedule. Underground sprinklers function through means of basic electronic and hydraulic technology. This valve and all of the sprinklers that will be activated by this valve are known as a zone. Upon activation, the solenoid, which sits on top of the valve is magnetized lifting a small stainless steel plunger in its center. By doing this, the activated plunger allows air to escape from the top of a rubber diaphragm located in the center of the valve. Water that has been charged and waiting on the bottom of this same diaphragm now has the higher pressure and lifts the diaphragm. This pressurized water is then allowed to escape downstream of the valve through a series of pipes, usually made of PVC (for higher pressure commercial systems) or polyethylene pipe (for typically lower pressure residential systems). At the end of these pipes and flush to ground level (typically) are pre-measured and spaced out sprinklers. These sprinklers can be fixed spray heads that have a set pattern and generally spray between 7-15 ft., full rotating sprinklers (or gear-driven rotor sprinklers) that can spray a broken stream of water from 20-40 ft., or small drip emitters that release a slow, steady drip of water on more delicate plants such as flowers and shrubs. Today, one can typically mix any brand sprinkler head with any brand sprinkler base (i.e. the body component) with any brand sprinkler controller and any brand control valve. Each of these typically require adjustments and offer some form of mechanical adjustment mechanisms for adjusting characteristics such as arc, distance, radius, angle, flow rate, pattern, and the like.

Today, all garden hose nozzles, sprinklers, oscillators, and the like are non-electronic in nature with respect to their micro-adjustment operation. Manufacturers such as Dramm, Gardena, Gilmour, Hunter Industries, Rain Bird, K-Rain, Toro, Nelson, Sun Joe, Little Big Shot, Ray Padula, Melnor, and Orbit provide nozzles, sprinklers, and so forth, but all are mechanically adjustable. For example, while sprinklers may have powered solenoid valves, the finer level adjustment settings, such as arc and radius, are not electrically adjusted, but rather mechanically adjusted with tools or directly by hand.

There are electrically power sprayers in the form of spray guns found in prior art, but the power is being utilized to pump a spray or stream of fluid from a container or boost the flow and frequency of fluid, versus being able to both electrically control the settings of the nozzle and electrically operate the nozzle. They also do not provide mechanisms for electrically setting presets based on one or more variables. There are also power battery operated flow meter attachments—however, they provide only an electronic display to show much fluid passes through, but they do not provide powered adjustment capabilities, nor have automatic shut-off while not in use, nor have functionality for users to define their own preset configurations.

It is the object of the present invention to provide a handheld (e.g. sprayer nozzle) and frame-based non-handheld (e.g. sprinklers, oscillators, and drip emitters) electronic nozzle that is fully modular in nature. It is the object of the present invention to provide a nozzle which houses one or more electric motors; transmission(s) for control drive optimization; electronic controls to operate, view, select, and adjust features of the present invention; and communication methods to adjust settings of nozzle heads.

Adjustable water nozzles including conventional sprayers, conventional fans, conventional wands, conventional sprinklers, and conventional oscillators are capable of delivering softer volumes of water, yet can mechanically adjust to deliver sprays that are further to reach that typically would normally require repositioning or changing the replacing the entire nozzle from the hose to a different type. For example, a gardener may switch between a simple hose nozzle to a pattern sprayer to complete their full set of tasks or simply use pattern sprayer and adjust the sprayer according to their needs. In addition, when an adjustable sprayer is used, the operator must mechanically adjust the nozzle to adapt for their specific needs. For example, an adjustable trigger includes a manual operation shaft which controls the volume of water entering the barrel. A knob is typically today connected, as shown in all related prior art, to the operation shaft and located on the barrel in some location on the body so that the user may mechanically rotate the knob to change the volume of water entering the barrel, which should not to be confused with the actuation trigger which brings it from closed to open state. Depending on the location of the knob or adjustment mechanism, the operator may still wet his/her hands in the adjustment process.

In another example, a pattern trigger nozzle includes a mechanical front turret which controls the pattern of water dispensed from the barrel of the nozzle. Patterns are selected with a mechanical twist of the front turret while on that clicks into preset configurations defined by the manufacturer of the nozzle, while off and flow rate are controlled mechanically with a knob, a button, or a one hand lever, handle, or trigger. Depending on the construction of the nozzle, the operator may still wet his/her hands in the process while adjusting the nozzle pattern due to the inherent fact that there are external moving parts and each are typically subject to leakage in all related prior art.

Typically in adjustable pattern nozzles, the operator must mechanically switch between patterns by twisting several times and may even miss the one that they desire only to have to twist the turret back to the preset configuration required. The nozzles typically have printed labels or are engraved for each of the patterns, and if the nozzle is dirty or the labels are faded or worn away, the operator must take note of the pattern while in operation in order to switch between the patterns, thereby increasing the likelihood that the operator may wet his/her hand, body, clothing, and so on in the process, as the operator may need to change the pattern while the nozzle is in use versus from his/her memory, and this may lead to difficulty in performing relatively simple tasks such as watering rose bushes and then palm trees. It should be noted, that for those with nearsightedness, farsightedness or eye disabilities, the operators must observe the sprayer pattern while adjusting the pattern in while operating the nozzle i.e. the sprayer is dispensing water and also keep track of turret rotation. Furthermore, adjustable sprayers are prone to fail at some point in time due to normal wear and tear as these adjustment controls are frequently mechanically changed, are subject to leakage, and often require two hands to make adjustments while in operation (e.g. one hand to hold the barrel or body, and the other hand to adjust the turret).

Nozzles may become slippery and difficult to handle when wet and require some form of physical strength. They leak water if not fully closed or tightened, such as the pattern sprayer nozzle which has a center screw subject to a constant flow of water during normal operation. They also offer no smooth transition from open to closed as in the case of the adjustable pattern sprayer nozzle. As a result, mechanical adjustable nozzles may be difficult to grip adequately while opening or closing the valves, turning the turrets, and adjusting mechanically operated buttons and knobs, and may eventually lead to water leakage if not properly closed or leak in the case of normal wear and tear. Since the valve adjustments are typically located close to another mechanical feature such as a trigger that also involves manual operation, opening and closing the valve and switching between patterns can cause accidental re-adjustments via the operator's hands and/or are sometimes even difficult to adjust (e.g. turn, crank, adjust, press, pull, push, etc.). These problems are especially difficult for people with reduced or impaired gripping abilities, such as some of the elderly or people afflicted with debilitating conditions. It also is difficult to operate multiple settings for every use, and requires effort and some skill to do this on a daily basis. In addition, old valve based residential or commercial nozzles may be difficult to adjust, or tighten after months to years of exposure to the elements. They may also be dirty or accidentally damaged. In addition, the adjustment features of some nozzles, particularly those readily used by others, may easily be broken.

Irrigation systems, such as sprinklers, typically include a plurality of underground pipes connected between sprinklers and valves, the latter being controlled by an electronic irrigation controller. One of the types of sprinklers is the pop-up gear-driven rotor-type sprinkler. In this type of sprinkler, a cylindrical riser is retracted into an outer cylindrical case by a coil spring. The case is buried and when pressurized water is fed to the sprinkler the riser extends itself, i.e. lifts. A turbine and a gear train reduction which is encased in its own housing are mounted in the riser for rotating a nozzle turret at the top of the riser. A reversing mechanism is also typically mounted in the riser along with a mechanical arc adjustment mechanism. It is more common today to have sprinklers that can be adjusted to operate in either an oscillating mode or a non-oscillating mode. Large versions of these sprinklers often have more than one nozzle mounted in the nozzle turret. One primary nozzle and one or more secondary nozzles are mounted in the nozzle turret. A method has been to provide a replaceable nozzle in a fastened holder for which a user can interchange them over time. The primary nozzle is used to spray a stream of water that extends far out. The secondary nozzles are used to spray shorter streams of water that water adjacent areas.

What is needed to overcome these disadvantages described above for mechanically-adjustable nozzles (e.g. sprayers, wands, fans, sprinklers, oscillators, drip emitters, and the like) is an electronic nozzle with an interchangeable set of electronic components (i.e. replaceable nozzle heads) that is simple to operate yet can provide electronic features for controlling the adjustment settings, easy to clean, lubricate, and detect and replace components, as well as easy to store, replace batteries, and charge batteries. To overcome the shortcomings of all prior art found today in the marketplace, the present invention provides an adjustable nozzle that can adjust the fluid flow using precision electronics in order to adjust and operate via an electronic control interface on the nozzle itself or remotely via a smartphone, an Internet application, a base station control unit, and a base station controller. Such a nozzle would be attractive to consumers for having both a reduced cost overall due to the reduced number of nozzles required having to be purchased as well as its ease of operation and making adjustments via its design and construction as declared in this present electronic invention.

Those that are impaired with one of their hands would find the present invention of great use since it requires only one hand to operate the apparatus. Adjustments can be made as the device is resting in the palm of one's hand, similar to the single hand operation of an electric shaver; portable toothbrush; and power hand tool. Before this invention, one has always had to use one or two hands to mechanically operate a pattern turret nozzle, making it virtually impossible to easily adjust the settings while operating the device. The present invention now opens the opportunity for those who wish to operate a n-pattern nozzle or adjustable nozzle, given that adjustments can very easily be made with a thumb and fingers while the device is held in the palm of one hand.

The electronic nozzle consists of a main body onto which different nozzles, can be snapped on or in, or screwed on or in by a consumer—like Lego bricks. Each nozzle is responsible for a unique set of functions. As a result, instead of replacing an entire nozzle when it becomes obsolete or broken a nozzle tip over time, one can simply replace the defective or performance-limiting part. This applies also to other form factors such as sprinklers with interchangeable rotors, etc. One could also simply switch out the nozzle end component (i.e. the outlet head of the nozzle) with a different nozzle end component to serve another set of functions. The simplest nozzle is a gun-type handheld nozzle with little adjustment capabilities. For example, if the consumer wants a specialized nozzle that suits another set of needs from the current attached simple nozzle, he or she can swap their original simple adjustable nozzle for a larger n-pattern nozzle (from the same manufacturer or even a different manufacturer instead of having to purchase altogether another complete nozzle tip, fan head, oscillator, sprinkler head, or wand, as it is today). In theory, this would lead to fewer people purchasing entirely new nozzles. This, in turn, would decrease an ever-increasing problem of waste (of both non-electronic and electronic products). Components based on the invention could be sold part by part, as well as packaged together in starter sets to save the consumer in overall cost of ownership. For example, a three-pack nozzle set sold today can be replaced with a single electronic nozzle body component, and three nozzle heads. When assembled, the nozzle system would have a core component covering most of the functionality, including electronic control buttons, electronic switches, electronic display interfaces, removable hose connectors along the edge, along with nozzle attached components (i.e. clicked into the front or top or side, screwed into the front or top or side, etc.), and an optional wand or sprinkler base (such as a pipe or hose) or oscillator base component which may add additional controls and display interfaces extended from the bottom of the main body, forming a complete nozzle (or wand or sprinkler assembly, etc.) shape overall. A broken nozzle tip can be replaced by a new nozzle tip similar or identical in nature to the nozzle being replaced and replacement parts can be sold in home improvement stores or online allowing consumers to easily replace key parts.

Today, products such as: electric and battery-powered power toothbrushes; electric and battery-powered drills; electric and battery-powered rotary tools for cutting, carving, grinding, scraping, sanding, polishing, routing, and so forth; and electric shavers, trimmers, and other electric and battery-powered grooming devices support interchangeability. That is, each have a handle or barrel body component, and supports a plurality of heads. For example, electric toothbrushes contain several brushes which can be interchanged; drills contain an assortment of drill bits, chucks, and adapters; rotary tools include cut off wheels, sanding bands, sandpaper discs, polishing wheels, grinding stones, dressing stones, mandrels, wrenches and so forth; and trim-shave-groom kits contain an assortment of shaving blades, trimmers, and so forth. In addition to this, they all typically provide a charger and travel case. The present invention supports interchangeability in that each has an electric handle body component (in the case of the spray nozzle, the first preferred embodiment, and sprinkler nozzle. the second preferred embodiment) and an assortment of adjustable nozzle heads or tips that are electronically controlled and adjusted, along with a charger, a charge station, and a travel case.

The primary embodiments of the electronic user interfaces provided in this invention include various sub-embodiments with different arrangements of the electronic control devices consisting of electronic-based knobs, dials, switches, and/or buttons such that the user interface is very simple and easy to understand and operate by any operator.

The present invention includes three key components: the electronic nozzle base (or “case” or “housing”), the electronic nozzle head (or “tip” or “end”), and the charging station or charger. The charging station may offer cleaning, lubrication, and mode selection, in addition to charging/re-charging the rechargeable batteries contained within the electronic nozzle. The electronic nozzle itself (i.e. base and head) is designed to be functional in every detail, where details matters and forms a perfect fusion of form and function to create the best nozzle: including its ergonomics, selected materials, selected surfaces and textures, and interfaces. For example, the textured handle is provided in one embodiment that provides an ideal grip position for the operator's hands while operating the nozzle. The present invention is designed to fit an operator's hand naturally and intuitively, in the case of handheld nozzles. The ergonomic, curved shape and the perfect positioning of the interface touch points allow best handling in every situation. The surface materials may be easy to clean in some embodiments that allow a user to simply wipe dirt and debris off smooth chrome based housings and nozzle ends. This design also includes a microcontroller which houses the memory, microprocessor, communications module, GPS, gyroscope, and logic. The integrated microcontroller operates within its body for easy and more accurate water flows and patterns and offers easy to store and use configurations. The multi-locking mechanism locks the fully flexible electromechanical nozzle in positions to achieve a more precise and repeatable flow rate, pattern, arc, radius, angle, and so forth. This is especially helpful when watering hard to reach areas, or watering sensitive plants, and so on. The material choices include rubberized, stainless steel, aluminum, bronze, brass, etc. and/or textured grip zone features including tread-like or dot patterns, and so forth. This ensures safe and confident handling even in wet conditions for which nozzles are typically operated in. The electronic nozzle also is provided with state-of-the-art Li-Ion or Ni-MH batteries although the operator may choose to purchase more inexpensive versions which simply use AAA or AA batteries. The electronic nozzle also offers displays including light emitting diode (LED) displays and/or LCD screen-based displays for adjustment, charge, power and operation (i.e. whether the device actuated and receiving and dispensing a fluid), locking, current charge remaining, whether a device is charging, a flow meter to indicate how much water flows through the outlets, and the like.

This invention, as described above, also includes a charge station that can rapidly charge the electronic nozzle. The electronics need not be turned on always during normal operation, as a trigger-based or other type of actuator only requires pressurized water or other fluid source for dual-mode electromechanical/mechanical embodiments. In other embodiments which are entirely electromechanical, the power must be on during use. In yet other embodiments, the power may be on but offered with manual override. The power for everyday use may only be needed for changing the settings and not while operating the nozzle. In some circumstances, it may require the powered electronics during use—however, they needn't be used for adjustments unless variations/adjustments need to be changed while the nozzle is in operation. The Li-Ion or Ni-MH battery delivers power reliably and offers a quick-charge mechanism for one use in preferably only a few minutes. The LED displays provide all information at a single glance—the LED displays show current battery status, operational status, clean status, a water flow indicator (e.g. with a LED bar graph or similar) a pattern indicator, lock indicators, etc.

The present invention includes the following features: multi-flow, pattern, on-off switch, locking switch, meter displays, 100% waterproof design, safe and portable for use both indoors and outdoors, Li-Ion or Ni-MH battery technology, LED display and electronic controls, multi-mode LEDs for lighting and easy night-time identification (e.g. sprinklers are typically damaged by those who accidentally kick or step on sprinkler heads), interchangeable components such as nozzles, wands, sprinklers, oscillators, and the like; a charging/cleaning station; as well as interchangeable pouches, belt clips, and charging cases (where an operator can simply plug in the case for which the operator stores the nozzle in without having to remove the nozzle).

IoT communications are also contained within the present invention—therefore, adjustments can be either performed at a desktop, via a base station, a controller, a control unit, a smartphone, a remote control, or via the electronic controls and display modules. The communications module may vary by model and price may be a factor as to which type of feature-enriched modules are included, such as a communications module. For example, it is possible that a sprinkler installer only purchases one electronic body to adjust a plurality of sprinkler heads. This would significantly lower the cost for the residential consumer and ease the installation process for the sprinkler installer. The electronic nozzle head may be adjusted via the electronic nozzle body, but during normal operation, the electronic nozzle body may be replaced with a cheaper non-electronic replacement. It may be the case that the nozzles heads are adjusted via electromechanical means but the electromechanical component is removed after installation or adjustments have been made in order to reduce the overall cost of installation.

The present invention may take on different forms—from an electronic pistol-type or barrel-type nozzle to a cylindrical-can-type nozzle (e.g. sprinklers, oscillators, drip emitters), for which the overall nozzle style is determined by the components and their purposes—but all models rely on electronic control and display devices. More particularly, the style is determined by the structure of the body, the structure of the nozzle head, and the structure of the actuator control which may be a trigger, lever, handle or an electronic control. This affords a plurality of possibilities of shapes and forms, ranging from a pistol-type spray nozzle to a sprinkler assembly. For the sprinkler assembly, the barrel may take on the form of a cylindrical sprinkler pipe and the nozzle may be a pop-up impulse, adjustable sprayer nozzle, etc. It should be emphasized that all electronic nozzles share similar characteristics as defined in this present invention.

Different embodiments may feature multiple patterns of fine, evenly spaced grooves, medium, or coarse holes and grooves that operate in an independent manner—twin nozzles, wands, and an integrated core component work together. Together they can effectively water with every operational watering capability that can be reasonably imagined. This present invention is specifically designed to deliver a flexible and efficient mode operation for the most selective operator, that can easily water in even more difficult conditions (e.g. small plants which require drip watering to larger plants such as palm trees, and so forth). In another embodiment, the electronic nozzle may have multiple nozzle patterns to easily adapt to most watering conditions. In yet another embodiment, the electronic nozzle may be made of tough and rugged industrial quality materials which can be used on construction sites, industrial operations, and commercial properties, including pools, golf centers, hotels, ships, and the like.

In another embodiment, the electronic nozzle head may be adjusted via the electronic nozzle body. but during normal operation, the electronic nozzle body may be replaced with a non-electronic more economical body, whereas with other embodiments, the electronic body component is used during operation with the electronic nozzle head in order to provide real-time adjustable functionality at all times—not merely to adjust prior to use or after use.

This invention most specially pertains to an electronically (or “electrically”) operated nozzle with a nozzle end unit (or nozzle “head” or nozzle “tip”) of the type that is adjustable into various operable external and internal positions: and interchangeable with other nozzle head units, having at least one electric motor and at least one fluid dispensing nozzle end, an actuating switch, a variable pattern controller, such that the nozzle end is adjusted by electric motor driven gears and is adjustable in and out of at least one operating position—that is, the nozzle end can be controlled by an electric motor-driven transmission unit (the gears to and from at least one operating position).

The present invention has arisen to reduce costs for those that end up having to purchase multiple nozzles (to serve different purposes or replace the entire nozzle when broken or worn) which lack the functionality as provided in this disclosure, and provide simple yet very advanced electronic capabilities to electromechanically control the flow of water or adjust a plurality of patterns.

It is becoming increasingly important that sprinklers, garden hose nozzles, and the like make efficient use of water. There have been several attempts to adjust the amount of water applied to landscape plant life by landscapers and homeowners by using products that are optimized for such conditions—however, what is typically found in home improvement stores are nozzles that are subject to breakages, leak on fittings/de-fittings, and offer no electromechanical mechanisms for even the simplest adjustments. Sprinklers are also subject to similar issues—there is no way today to adjust them electromechanically without requiring external tools such as a collection of mini-wrenches which each serve a specific purpose and manufacturer, and no method for, remotely making finer tuned adjustments from the comfort of one's home. Although there are smart irrigation controllers for controlling general flow volume and year/day/time of operation of sprinklers, there are no smart sprinkler adjustment control interfaces which can be controlled by anyone using an Internet application. a mobile smartphone app, or a simple electronic control device/interface to control the actual adjustments of the nozzles. The adjustment control interfaces provide for finer levels of adjustments thereby allowing for finer control of nozzle flow, pattern, frequency, arc, angle, distance, and so forth.

Quick connect and quick disconnect systems, also referred to as coupler systems, are utilized in a variety of aerospace, industrial, household (e.g. residential), medical, pneumatic, hydraulic, and commercial applications. The nozzle applies this field for use within the electronic nozzle for both connecting the head to the body and the body to the hose, tube, or pipe.

Coupler systems typically include a first connector and a second connector. The first connector is typically associated with a fluid device and the second connector is typically associated with a fluid conductor. In the case of the electronic nozzle, a coupler system is configured for use with a fluid device provided as a water nozzle and a fluid conductor provided as a hose. The first connector is connected to the nozzle and the second connector is connected to the hose. The coupler system simplifies connecting and disconnecting the nozzle from the hose, as described below, with reference to a typical connection of a spray nozzle to a hose. The coupler system may also be configured for use with the nozzle head and the nozzle body.

The conventional coupling includes an internally threaded end portion that is connected to one end and an opposite externally threaded end portion. Coupler systems in the present invention seek to simplify the above described process by making connection of the nozzle body to the nozzle head fast and easy. It also makes the connection of the nozzle body to a hose (in the case of sprayers) or pipe (in the case of sprinklers) fast and easy.

Even though coupler systems seek to simplify connection of a fluid device to a fluid conductor, coupler systems typically suffer from numerous problems. First, some coupler systems include a locking feature that is difficult disengage, especially when the fluid in the fluid conductor is under pressure.

This invention discloses and describe a connector system for fluid systems that is electronic in nature, and can alert an operator that a connection has been broken. Even if a coupling today is secure, there is no guarantee that the connection has been fully made—this new invention further provides a method for which an operator can more easily detect water leakage and disconnection.

### SUMMARY OF THE INVENTION

The electronic nozzle has a main body in various forms (e.g. spray nozzle body, sprinkler body, and so forth), a plurality of electromechanical adjusting members, a flow control shaft, a nozzle spray head offered in various forms (e.g. pattern, adjustable, rotor, impulse, etc.), a trigger or other electronic control, an on/off control switch, electromechanical adjustment controls, electronic displays, power indicators, and so forth. The trigger or electronic control is capable of staying in fixed status, and an electromechanical adjusting member can drive the flow control shaft to rotate to provide adjustable flow as or after the handle, trigger, or electronic control is fixed (either mechanically or electronically). The electronic nozzle which consists of a main body can accommodate different (i.e. replaceable, interchangeable, detachable) nozzle attachment heads and extenders (e.g. sprinkler/oscillator bases and nozzle extending wands) that can be snapped on by a consumer like Lego bricks or threaded in like conventional hose attachments. Each nozzle head is responsible for a unique set of functions. As a result, instead of replacing an entire nozzle when it becomes obsolete or broken, one simply replaces the defective or performance-limiting part. One also simply replaces the nozzle end with a different nozzle end to serve another set of purposes. For example, if the consumer wants a nozzle that suits his or her needs better, he or she could for example swap their original nozzle for a larger pattern nozzle from the same or different manufacturer instead of buying an entirely new nozzle or wand or sprinkler system. In theory, this would lead to fewer people purchasing complete new nozzles and reduce the ever-increasing problem of electronic waste. Interchangeability also applies to handles, triggers, accessories, and the like. Components based on the invention are to be sold part by part, as well as in starter sets. When assembled, the system has a core component covering most of the functionality—the control buttons, display interfaces, and a hose connector along the bottom edge, and an end nozzle clicked into the front or top or side, and an optional wand extended from the top of the main body to the bottom of the end nozzle head, forming a complete nozzle or wand shape overall. There is no requirement, however, that the system provide for interchangeability of nozzle ends and wands, only that this system is electronic in nature and that there is minimal support for modular components (a broken nozzle can be replaced by a new nozzle similar or identical in nature to the nozzle being replaced).

An electronic nozzle disclosed herein includes the body, the trigger, or some other form of control button(s) for the actuator(s), a power switch, an electronic control interface, an electronic display interface, a removable water or pattern adjustable nozzle head (conventional, sprayer, fan nozzle, gear-driven rotor sprinkler, oscillator, etc.) and provides for removable wands or other attachment assemblies. The electronic nozzle may include a secondary body that sits in front of the nozzle head (such is the case for sprinklers) so that multiple adjustments may electronically be made (on the base of the sprinkler head for which the head resides or at the top of the sprinkler head so that additional micro-adjustments can be made).

In most embodiments, the body houses: a nozzle end connector; a trigger, lever, or electronic actuator for controlling the water flow after settings have been made; an electronic control device; an electronic display interface, an inlet attachment connector such as a sprinkler/oscillator assembly connector, a pipe/case connector (ideal for sprinklers), or hose connector; an internal electronic control system, the adjustable plurality of inlets and outlets (preferably one to two inlets and one to two outlets); an electric motor with transmission modules; and a removable rechargeable battery pack (or module). A switch within the body is actuated by the nozzle trigger or handle, wand trigger or interchangeable handle, and/or buttons to control the fluid flow. Circuitry connects the batteries; the electric motor; the drive shaft/transmission; the nozzle electronic control devices; the electronic displays; the electromechanical nozzle chuck(s); the electromechanical valves (such as variable force solenoid valves), the multi-mode light emitting diodes for lighting or illumination (e.g. sprinklers can be illuminated at night by a flashing signal); the timeout shut-off functions; the optional attachment sprinkler, oscillator, wand controls; and the electronic nozzle end attachments in the case that the nozzle end attachments are electronic in nature; an IoT communications module for emitting notifications for operational status in order to prevent water loss; an optional gyroscope module which is used to control the general operation of the nozzle—for example, if the nozzle is pointed vertically at 90 degrees from normal operational mode (horizontal) the system shuts off, and so forth. Both electronic and manual controls operate the operation shafts so that the user can adjust the volume, pattern, arc, angle, radius and frequency of water that enters or exits the nozzle.

The sprayer nozzle of the invention is assembled from a total of several components. In the preferred embodiment for the typical hand-held hose nozzle (used in either commercial, industrial or residential applications), the component parts are assembled using various types of metals, rubbers and plastics. The component parts of the nozzle in the primary embodiments include a two-piece housing, a control valve assembly contained in the housing, an electronic or mechanical actuator (such as a trigger, interchangeable handle or button) mounted on the housing, a hose connector mounted on the housing; control valve(s); electronic drive shaft(s); electric motor(s), and a spray deflector.

The simple two-piece housing includes a housing front piece that is snap-fit to a housing back piece for ease of disassembly and assembly. Together, the two pieces define a housing having an interior hole (or bore) that passes between an inlet end of the housing and an outlet end of the housing. The interior bore defines a fluid flow path through the housing between the inlet and outlet ends.

A hose connector containing a washer or gasket is mounted to the housing inlet end for rotation of the connector relative to the housing. The hose connector connects (i.e. mates) with the typical exterior threading of a home garden hose or an electronic quick connector. The housing may also have a second connector that is connectable to a separate product container for car washing or fertilization, etc. in another preferred embodiment. In this other embodiment, the second connector is a connector that can be releasably attached to a bottle of product such as soap/wax having a complementary connector.

A control valve assembly is mounted in the fluid flow path in the housing interior bore. The control valve assembly includes a control valve that has an interior hole that functions as an inlet for fluid flow path through the nozzle. The control valve is mounted in the housing for reciprocating movement of the control valve along the flow path. A backflow check valve may be mounted in the interior hole of the control valve and permits liquid flow along the flow path from the inlet end of the nozzle housing to the outlet end, but used to prevent reverse flow through the flow path from the outlet end to the inlet end.

The two-piece manual or electronic actuator is mounted within the nozzle housing (which differs from all other prior art) and is operatively indirectly connected with the control valve via the microcontroller of the system. The actuator is an electronic device (either an electronic-based knob or electronic set of arrow buttons, or interface control, etc.) that communicates with the system microcontroller. There may be multiple actuators within the electronic nozzle. The electronic-based actuator causes the control valve to indirectly (via the microcontroller) open or close along the flow path in the housing interior hole in response to settings of the actuator. The microcontroller communicates to the drive shaft(s) of electromagnetic motor(s), which in turn opens and closes the control valve(s).

The parts of the electronic nozzle of the invention described above provide the nozzle with a simple yet very advanced technology construction. In addition, they provide the nozzle with several desirable interchangeable and fixed features, i.e., for fixed, the ability to stop flow through the nozzle, gradually open flow through the nozzle, gradually open second chamber liquid flow through the nozzle, and gradually close flow through the nozzle. In the case of a secondary container embodiment, the nozzle has the ability to mix with a separate product as it gradually opens the liquid flow. In addition, the concentration of the product mixed with the liquid passing through the nozzle can be adjusted electronically. Still further, the outlet fluid from the core to the electronic nozzle end can be directed as a stream from the nozzle or can be deflected in a pattern via the attachable nozzle end, depending on the nozzle end that is attached to the housing unit. By providing valves and drives that electromechanically rotate about the center axis or off-center axis of the nozzle housing from either the interior or exterior of the center axis or off-center axis flow chamber, the different options available to alter the dispensing of water (or other fluids) from the housing are easily controlled via the electronic control interface, using mechanisms similar to a drill, power tool, or rc helicopter motor (rotating drive shaft). By providing modular attachments such as simple adjustable nozzle heads to more complex fan heads, electromechanical-adjustable sprayer heads, and electromechanical-adjustable sprinkler heads, the different options available to alter the dispensing of fluid such as from water from the housing main component are easily controlled via the electronic interface and driven by the electronic microcontroller. In other embodiments, the valves can differ from simple ball valves electronically rotated, to variable force solenoid valves that are opened and closed depending on the voltage, and so forth.

One of the key premises in this invention is that technology may change fairly quickly as the inventor offers the products to the wide marketplace. The electronic concepts covered in the present invention is for how electronic user interfaces should work best in this form factor from the controls (buttons, etc.), to the displays (bar graphs, power on indicators, operational status indicators, battery level indicators, and so forth) to its charging capabilities, to shut-off controls, and so on. The electromechanical technology in the present invention pertains to the plurality of adjustment valve operations (i.e. various rotate and control variations), on how the nozzle ends are attached via a chuck-type system or an electronic based solution where the nozzle heads may also be electromechanical in nature, and for how the triggers and other actuators would need to operate, etc. The purpose of this invention is to replace conventional nozzles (such as traditional nozzles, wands, sprayers, sprinklers, fans, and oscillators) and is an object of the present invention. Different types of nozzle ends are introduced, in order to replace the multitude of products on the market today. The conventional drill chuck concept for nozzle end rotations needn't be used in all embodiments of this design or linear motor driven movements, since a connection from housing to nozzle end may also be made via electrical connections (power-related connections) in order to support extensions (i.e. nozzle head attachments) which provide their own electromechanical technology based on control signals provided from the microcontroller of the nozzle body and their own batteries and charging units. Nozzle heads may also even be charged while connected to the main housing (e.g. case, gun-type, barrel-type, etc.).

The core electronic modular framework contains all the functionality required as disclosed above plus additional empty slots for easy adding and swapping of newer features. All modules fit easily into the electronic framework, allowing for upgrades, innovation, and feature sets, such as additional IoT capabilities, gyroscope capabilities, audible speakers for the visually impaired, sensor or time based configurations, GPS mapping for automatic presets depending on location, etc. This invention isn't just about modularity of hose ends or hose inlet attachment devices for mixing, matching, and swapping with others or other manufacturer nozzles, sprayers, sprinkler heads, and the like—it's also about the ability to connect electronic internal modules into any slot over time and it simply works with the new modules featuring new technology. The framework is built with durable latches and connectors to keep the modules secured in the frame while in heavy-duty operation and accidental handling of the nozzle. The modules are designed around “I-METRO standards”, allowing them to work with new next-generations of devices such as nozzles, wands, sprinklers, oscillators, water faucet nozzles, and the like.

The framework contains the microcontroller/microprocessor, printed circuit board, memory, a removable rechargeable battery assembly, the electronic controls and displays. The electronic framework baseplate provides an instant connection to the frame and its core technologies. That means less time re-designing electronic printed circuit layouts in order to provide future functionality and less time re-inventing the same concept.

A printed circuit board (PCB) electrically connects electronic components using conductive tracks, pads and other features etched from copper sheets laminated onto a non-conductive substrate. Components—capacitors, resistors or active devices—are soldered on the PCB. Advanced PCBs may contain components embedded in the substrate. The microprocessor board is the printed circuit board containing the microprocessor and the support logic needed for the electronic nozzle.

The electronic core is divided into four independent electronic-based modules: the main microcontroller, the core, the (optional) IoT module, and the battery module. The microcontroller module includes the controls and displays; and the core module consists of processing, ROM and RAM and other electronic parts. The IoT module can be used to report operational status to base stations, controllers, control units, and mobile smartphone software via an intermediate server, as well as for remotely configuring the presets of the electronic nozzles. For example, today, in order to install and configure a sprinkler, one typically configures the sprinkler head, then threads the sprinkler on the irrigation pipe. The sprinkler then is buried flush to grade. With the IoT communication module, the configuration can be set at any time (e.g. before installation, during installation procedures, and after installation). This is a huge advancement in the irrigation product industry. For pistol nozzles and the like, the IoT communication module can be used to pre-configure settings that can be used on the field. This may prove to become very useful for commercial applications and residential gardening for gardeners, landscapers, and other operators. Another powerful feature of IoT communication is being able to observe the operational status (including leakage, rechargeable battery status, operational states, etc.) of the sprinklers and garden hose nozzles, etc. For example, the gardener may want an advanced adjustable nozzle and adjustable pattern sprayer, each optimized to their own configurations. A simple garden enthusiast may only need an all-in-one adjustable pattern/flow nozzle. An irrigation specialist may want a push-up rotor head attached to the electromechanical cylindrical base. Consumers who are fond of having multiple nozzle heads (such as patterns nozzles, wand nozzles, fan nozzles, etc.) can change to nozzle ends instead of having to purchase a new sprayer. This also applies to sprinklers, oscillators, drip emitters, and the like.

In addition to the electronic nozzle core features, there are additional electronic features such as lighting of the surroundings while in operation—illumination may be simple as flashing or steady lights for sprinklers to avoid accidental damage from nighttime pedestrians and golf carts, etc. This invention also provides for vibrating pulses or bursts of fluid at times due to incorporating electronics into this design.

The design also provides for capabilities such as gyroscopic controls to operate presets or turn off the flow in the case of operation where the body is turned accidentally to a steep angle (e.g. between 75 to 90 degrees perpendicular to the ground, the nozzle shuts off the inlets and/or outlets). The electronic nozzle can sense the motion of one's wrist in order to change flow and pattern of water.

This design also provides for easy shut-off and IoT Wi-Fi, Infrared, Bluetooth, or Micro-USB communication to and from a base station, controller, control unit, mobile smartphone, and/or Internet server. Several embodiments of the present invention generally relate to an electronic controller that adjusts the arc, radius (distance of throw), pattern, flow opening, flow rate, nozzle location, direction of flow, etc.

In one embodiment (e.g. a gear-driven rotor sprinkler), a method for use in sprinkler adjustment control comprises: receiving, from a user via a user interface of an on-board or Wi-Fi, Infrared, Bluetooth, or Micro-USB connected control unit and at a time before or after an initial sale of the control unit, an identifier corresponding to a sub controller of the internal controller, wherein the control unit is external to and at a location of the controller (i.e. on the sprinkler itself) configured to execute operation (e.g. adjust the sprinkler); identifying, by the control unit using the identifier, a set of values of one or more settings variables from a plurality of sets of values pre-stored in a memory of the control unit prior to the initial sale of the control unit, wherein each of the plurality of sets of values corresponds to a different sub controller, wherein the values of each of the one or more settings variables stored in the memory comprise a plurality of values corresponding to different settings; wherein the one or more settings variables of each of the plurality of sets of values are useful in determining adjustment requirements, wherein the identifier corresponds to a sub controller having representative conditions indicated by one of plurality of sets of values stored in the memory; receiving, by the control unit, a current value of at least one other variable useful in determining the operational requirements from at least one sensor coupled to the control unit (such as GPS location or other location technology and nozzle directional compass which determines the direction of the nozzle center axis e.g., N, S, W, E, NE, etc.), at least one other variable being different from the one or more settings variables and comprising GPS; receiving, by the control unit, at least one value from the identified set of values of the one or more settings variables from the memory; determining, by the control unit, the operational requirements using the at least one value and the current value of the at least one other variable; outputting, by the control unit and based on the determined operational requirements, an adjustment control message to the controller; and adjusting, by the controller, execution of the operation stored by the controller in accordance with the adjustment control message. For example, if the nozzle contains a compass and GPS mapping system (either GPS from satellite or other means), the current location and direction of the nozzle tip will be used in setting the relative arc and throw.

For example, while adjusting the arc of a sprinkler, while the rotor is operating, an operator may only turn the arc adjustment in the direction the rotor is already turning. Turning it against the direction it is already turning can damage the rotor by stripping the gears, according to the lead manufacturers of gear-driven rotor sprinklers today. Hence, the direction, directional change, and/or location is required before actual electromechanical adjustments can be made in order to safely make the adjustments. Also, for example, with the water on or off, an operator can adjust the distance of throw. Since this is performed manually today, to perform this same operation remotely via Wi-Fi, Infrared, Bluetooth, Micro-USB or other similar communications technology, it would be useful to the operator to “know” the location or relative regional location (e.g. sprinkler right of front walkway) in order to know which adjustments should be made to the sprinkler without having to actually walk up to the sprinkler and adjust it electronically. In the case of handheld nozzles, it would be useful to know what type of nozzle it is if additional configuration settings are added to the electronic nozzle internal memory. For example, if an operator chooses to replace a nozzle m-pattern disk with their own 3d-printed n-pattern disk, the operator may wish to provide pattern settings via an Internet application or smartphone application which allows new settings to be stored in the system, In other cases, where there are multiple valve opens, such as water flow being partially provided via an adjuster and a pattern selector, the operator may wish to save the settings so that it may be used during operation of the electronic “smart” device nozzle.

In another embodiment, a control system comprises: a controller configured to execute an adjustment/operation; and a control unit external to and coupled to the controller, the control unit at a location of the controller. The control unit comprises: a memory storing a plurality of sets of values of one or more settings variables, each set corresponding to a different sub-controller, wherein the values of each of the one or more settings variables stored in the memory comprise a plurality of values corresponding to different adjustment settings, wherein the plurality of sets of values are pre-stored in the memory prior to the initial sale of the control unit, wherein the one or more settings variables of each set of values are useful in determining operational/adjustment requirements; a user interface configured to receive, at a time after an initial sale of the control unit, from a user an identifier corresponding to a region of the controller; a sensor input configured to receive values from at least one sensor; a first microcontroller configured to: identify, using the identifier, a set of values of the one or more settings variables from the plurality of sets of values, wherein the identifier corresponds to a sub-controller having representative conditions indicated by one of plurality of sets of values stored in the memory; receive a current value of at least one other variable useful in determining the operational/adjustment requirements from at least one sensor coupled to the control unit, at least one other variable being different from the one or more environmental settings variables and comprising GPS; receive at least one value from the identified set of values of the one or more environmental settings variables from the memory; determine the operational/adjustment requirements using the at least one value and the current value of the at least one other variable; and generate an adjustment control message based on the determined operational/adjustment requirements; and an output interface configured to output the adjustment control message to the controller. The controller comprises: an input configured to receive the adjustment control message from the control unit; and a second microcontroller configured to adjust execution of the operation/adjustment in accordance with the adjustment control message.

In another embodiment, a method for use in control comprises the steps: receiving, via a user interface of an control unit, user entered configuration values of one or more settings variables useful in operational/adjustment requirements, the user entered values corresponding to the sub-controller; storing the user entered values in a memory; receiving current values of one or more other settings variables useful in determining the operational/adjustment from one or more sensors coupled to the control unit, the current values corresponding to the sub-controller, one or more other environment settings variables being different from one or more settings variables; storing the current values in the memory; receiving one or more of the user entered values of the one or more settings variables from the memory; receiving one or more of the current values of the one or more other settings variables from the memory; and determining the operational/adjustment requirements based at least in part using the one or more of the user entered values of the one or more settings variables and one or more of the current values of the one or more other settings variables.

In another embodiment, a control unit comprises: a user interface adapted to receive inputs from a user; a memory adapted to store settings variables; at least one input adapted to be coupled to and receive signals from one or more sensors; and a processor coupled to the memory and the user interface. The processor is adapted to: receive, via the user interface, user entered values of one or more settings variables useful in determining operational/adjustment requirements, the user entered values corresponding to the sub-controller; store, in the memory, the user entered values received from the user interface; receive, via the at least one input, current values of one or more other settings variables useful in determining the operational/adjustment requirements from the one or more sensors, the current values corresponding to the sub-controller, one or more other settings variables being different from the one or more settings variables; store, in the memory, the current values received from the at least one input; and determine operational/adjustment requirements at least in part using one or more of the user entered values of the one or more settings variables and one or more of the current values of the one or more other settings variables.

In another embodiment, a method for use in control comprises the steps: obtaining a control unit configured and manufactured to determine operational/adjustment requirements based at least in part on values of a plurality of environmental settings variables, the control unit configured and manufactured to receive current values of a first set of one or more of the plurality of settings variables, the current values corresponding to a sub controller; determining a value of each of a second set of one or more of the settings variables, the values corresponding to the sub-controller, wherein the first set of the one or more of the plurality of settings variables are different settings variables than the second set of the one or more of the plurality of settings variables; and entering, via a user interface of an control unit, the configuration values of each of the second set of the one or more of the plurality of settings variables to be stored in a control unit for later use together with the current values of the first set of the one or more of the plurality of settings variables by the control unit in determining the operation/adjustment requirements.

The invention provides for easy charging via a charging station or directly plug-in via a connector with connector pins inside the housing of the electric nozzle. The body of the connector housing provides for easy access to a live electric socket outlet. According to a preferred embodiment of the present invention, provision is made for the connector pins to be of a round configuration to connect to a charging station, although other embodiments may provide other shaped connector pins including USB ports, etc. In one embodiment, the device has a built-in charging device which is designed to plug directly into a wall outlet or have a detachable cord. In another (and the preferred) embodiment, the electronic nozzle has a recharging base unit that plugs into an AC outlet and provides DC power at the base contacts eliminating the need for the AC-to-DC converter to be contained within the electronic nozzle, while reducing the risk of electric shock, especially since this device is prone to be around water (or other fluids) while in operation. In another embodiment, the electronic nozzle has a recharging base unit that cleans the nozzle components by immersing the nozzle head in a liquid container that cleans while the nozzle charges using an alcohol-based clean station which cleans, lubricates and charges the nozzle.

In another embodiment, preferably on inexpensive models, the electric nozzle uses removable rechargeable or disposable batteries, of size AA or AAA. This offers the more economical option of externally charging batteries using off-the-shelf charging units or simply replacing the inexpensive battery or batteries instead of having to add cost for an additional internal or external charging device.

In another embodiment, the electronic nozzle components are adapted into existing products. This embodiment takes the form of an adaption kit that utilizes various aspects of the present invention to work with third party manufacturers.

The quick connect/disconnect system as described herein is provided for connecting the nozzle head to the nozzle body and the nozzle body to a hose or pipe. The system is compact but sophisticated in how it connects to and disconnects from the nozzle. The system is electronic in nature with a user interface and a display unit and can instruct users on how to connect (such as two green arrows being illuminated in solid and flashing indication signals), whether a solid connection has been made (a solid and flashing indication signal), and whether the connection has been broken (via a solid and flashing red indication signal). Due to the nature of the display unit (e.g. LEDs), the connector is highly visible in both daylight and nighttime conditions.

The preferred embodiments for an electronic nozzle will consist of at least the following:

1. Electronic nozzle body component (or housing)

2. Detachable nozzle head

3. Nozzle release button(s) for nozzle connector

4. Nozzle head to nozzle body quick connector with LEDs

5. Nozzle hose or pipe to nozzle body quick connector with LEDs

6. Multi-adjustment-lock switch

7. On/off switch

8. Power indicator

9. Flow rate indicator

10. Trigger and/or electronic actuator for main control valve for fluid flow

11. Electronic, electromechanical, and mechanical nozzle controls for adjustments

12. Electronic nozzle displays for viewing, modifying and selecting configurations

13. Optional attachment(s) for spray nozzles and sprinkler nozzle components, such as hand-held wands and sprinkler extenders, etc.

14. Optional communications module such as Wi-Fi, 4G, Infrared, Bluetooth, Micro-USB, etc.

15. Nozzle-to-charging cord and station electrical contact(s)

16. Release button for inlet connections (such as a quick connector)

17. Manufacturer and model number of both nozzle body and nozzle heads for easy identification in replacement, upgrades, interoperability, etc.

18. Power cord set

19. Brushes (used for cleaning nozzle base and nozzle heads)

20. Hard travel case with optional built-in charging capabilities

21. Charging station (with clean, lubricate, and charging capabilities)

The embodiments for the present invention in the form of electronic spray guns, jet nozzles, fan nozzles, shower nozzles, stream nozzles, wand nozzles, sprinklers, and the like all are electronically easy to switch between water flow and pattern selections with the electronical-change features which offers ergonomic design with insulated grips, quick-touch pattern changing, and heavy-duty metal and plastic construction, available in numerous colors and materials. The various embodiments include shower, pattern, impulse, adjustable, rotary, pop-up and stream (jet) nozzles.

The main objective of the present invention is to provide an adjustable electronic nozzle for a hose, tube, or pipe that can adjust fluid flow in a very precise and repeatable manner. The adjustable electronic nozzle has a body, a valve assembly, electronics, and a detachable head. The body has an inlet, a nozzle and a plurality of valve chambers. The valve chamber is formed between the inlet and nozzle and has two ends. The body has one or more inlets, an electromechanical nozzle and one or more valve chambers. The valve chamber is formed between the inlet and nozzle and has two ends. The electronics are controlled to allow fluid to flow through the plurality of valve chambers. The valve assembly is rotated or linearly moved to adjust the water flow in very small increments.

In accordance with the principles of the present invention, an electronic nozzle, taking the form of a handheld electronic spray device or a base-mounted spray device is provided that is capable of receiving detachable accessories, and provides a battery powered source to power the detachable accessories in either a rotational or linear motion, or a combination thereof.

The present invention seeks to achieve these objects in at least one embodiment by providing an asymmetrical nozzle housing within a nozzle base of a sprinkler which, when electromechanically rotated, changes its angular orientation relative to the nozzle base. Since the electronic nozzle is disposed within the nozzle housing, it similarly changes angular orientation relative to the nozzle base, thereby modifying the trajectory of ejected water during irrigation. In this respect, a user can change the trajectory of a watering stream by simply electromechanically rotating the nozzle housing.

In one embodiment, an electronic spray nozzle for indoor or outdoor use is provided. The nozzle includes one or more electric motors for controlling and adjusting a nozzle via a drive train. The drive train has a driving wheel for driving a transmission element in engagement therewith. The driving wheel has a mounting portion mounted on a driving shaft connected to the electric motor. The engagement portion of the driving wheel is in engagement with the transmission element.

It is also an object of this invention to provide the electronic nozzle which can be adapted to electromechanical three-dimensional rotors which delivers the water in an x,y, and z axis and precipitation to an entire irrigation area which is interchangeable in different sizes for a different flow rate, that can be electromechanically adjusted.

It is an object of the invention to provide a rechargeable electric nozzle that is able to maintain a lock-off and a lock-on state.

It is an object of the invention to provide a rechargeable electric nozzle that has a standby or sleep switch which is arranged at the electronic control device part of the housing and is able to set the rechargeable electric nozzle to a sleep or standby state where the rechargeable electric nozzle waits for the motor(s) to be driven. The lock-on switch is arranged at the housing, and is able to shift the rechargeable electric nozzle from the standby sleep state to a state where the motor(s) is driven so as to keep the state where the motor is driven.

According to an object of the present invention, in the rechargeable handheld electric nozzle, gripping and control regions are formed on the housing, and the power switch and the standby (or sleep) switch and the lock-on/lock-off switches are arranged in the gripping or control regions. The gripping region and control regions include not only a region that an operator directly grips but also a region within a range in which a finger of the operator reaches from above (as in the case of spray nozzles) or from the side (as in the case of sprinklers, oscillators, and drip emitters).

According to another aspect of the present invention, the rechargeable electric nozzle includes a control unit with timer that controls the rechargeable electric nozzle such that the rechargeable electric nozzle is released from the standby state after a configurable pre-determined period of time has elapsed from when the rechargeable electric nozzle is set to the standby (or sleep) state by the standby (or sleep) switch.

It is the object of the present invention is to provide an electronic sprinkler in which a spray head can be adjusted electromechanically so as to spray fluid such as water relatively evenly.

The electronic sprinkler according to this invention (referred to as the second preferred embodiment) includes a fixed unit, a rotary unit, an impeller, a connector, and a spray head. The fixed unit has a water inlet. The rotary unit is mounted rotatably on and fluid flows from the fixed unit. The impeller rotates the rotary unit and is adapted to be driven by water from the water inlet. The connector is mounted on and water flows from the connector to the rotary unit. The spray head is mounted on and flows thru the connector to the spray head. The spray head is rotatable relative to the rotary unit so as to change an inclined position of the spray head. All adjustments may be made via electromechanical mechanisms of the present invention.

A better understanding of the invention will be obtained from the following detailed description of the preferred embodiments for electronic nozzles, and the set of claims, taken in conjunction with the attached drawings, with common components across embodiments. The above-described features and advantages, as well as others, should become more readily apparent to those of ordinary skill in the art by reference to the following detailed description and the accompanying figures in which:

### BRIEF DESCRIPTION OF THE DRAWINGS

FIG. 1 is a top view representing the first preferred embodiment, an electronic nozzle system configured to perform the techniques disclosed herein, in accordance with the various spray nozzle embodiments disclosed herein.

FIG. 2 is a front view representing the second preferred embodiment, an electronic nozzle system configured to perform the techniques disclosed herein, in accordance with the various sprinkler nozzles, drip emitter nozzles, and oscillator nozzle embodiments disclosed herein.

FIGS. 2B to 2E are additional front views representing the second preferred embodiment, an electronic nozzle system configured to perform the techniques disclosed herein, in accordance with the various sprinkler nozzles, drip emitter nozzles, and oscillator nozzle embodiments disclosed herein.

FIG. 3 is a block diagram representing the first preferred embodiment, an electronic nozzle configured to perform the techniques disclosed herein, in accordance with the various sprayer nozzle embodiments disclosed herein.

FIG. 4 is a block diagram representing the second preferred embodiment, an electronic nozzle configured to perform the techniques disclosed herein, in accordance with the various sprinklers, drip emitters, and oscillator embodiments disclosed herein.

FIG. 5 is a perspective view of the first preferred embodiment from top right, an electrically operated nozzle with a simple adjustable nozzle head attached to the body.

FIG. 5A is a perspective view of the first preferred embodiment, an electrically operated nozzle with an adjustable nozzle head attached to the body.

FIG. 5B is a perspective view of the first preferred embodiment, an electrically operated nozzle with an adjustable pattern nozzle head attached to the body.

FIG. 5C is a top view of a short body electrically operated nozzle of the first preferred embodiment, an adjustable nozzle head attached to the body.

FIG. 6 is an exploded perspective view of the first preferred embodiment, an adjustable hand-held electronic nozzle of the first embodiment, shown as an exploded set of parts, with parts of the adjustable nozzle assembly housing and the operating controls to expose more detail.

FIGS. 7A to 7D is a front perspective view of a LCD display interface which displays the current flow pattern that is currently selected by an operator, contained within the adjustable electronic pattern-turret type nozzle.

FIG. 7A is a side view of the first preferred embodiment, a short body electrically operated nozzle with an adjustable nozzle head attached to the body. The exploded part of the assembly is the LCD display interface.

FIG. 7B is a perspective top view of a LCD interface assembly for displaying the current flow pattern(s).

FIG. 7C is a various display forms that the current flow can be displayed on the LCD interface.

FIG. 7D is block view of the eight-pattern nozzle flow pattern included in the first preferred embodiment, which can be represented in a LCD interface, graphically and numerically, or a combination thereof.

FIG. 8 shows a perspective view of the first preferred embodiment, an adjustable nozzle attachment of the present invention, as seen looking from top left to the bottom right.

FIG. 9A to 9C are cross-sectional views of the first preferred embodiment, an adjustable nozzle attached to the muzzle of the electronic nozzle body.

FIG. 10 is a perspective exploded view of the operating motor and transmission of the adjustable nozzle assembly.

FIG. 11A is a two-dimensional top view representation of a handheld electronic spray nozzle according to the invention shown from the back to the front.

FIG. 11B is a top view representation of an electronic control/display device of the handheld electronic spray nozzle.

FIG. 11C is a top view representation of the fluid flow electronics for increasing and decreasing the flow, as well as for adjusting the nozzle head.

FIG. 12 is the perspective view of the LED display for the flow pattern indicator.

FIG. 13A is a side view of the electronic pattern nozzle.

FIG. 13B are two representative views of the electronic pattern nozzle being adjusted and operated.

FIG. 13C is a perspective view of the electronic pattern nozzle.

FIG. 13D is a side view of the transmission with drive shaft of the first preferred embodiment.

FIG. 13E is a front view of the electronic pattern nozzle attachment.

FIG. 14 contains a perspective view of varying scale that illustrates various key components of the present invention.

FIG. 15 is a front view of the second preferred embodiment, an electrically operated sprinkler nozzle with an adjustable nozzle head attached to the body.

FIGS. 16C to 16E is prior art of a top adjustment assembly from a leading sprinkler manufacturer. The present invention is illustrated in FIGS. 16A and 16B.

FIG. 17 illustrates the electronics for the twin motor assembly of FIGS. 16A and 16B.

FIGS. 18A to 18C illustrate how adjustments are currently made by a leading manufacturer.

FIG. 18D illustrates the side view of an electronic sprinkler.

In FIG. 19A, an illustration is provided for adjusting arc and radius of prior art.

FIG. 19B is a perspective view representing a right angle adjustor for the rotors as illustrated in FIG. 19A.

FIG. 20 illustrates details of the nozzle system of the sprinkler embodiment of FIG. 2.

FIG. 22 is a diagram of FIGS. 21A and 21B, in accordance with an embodiment of the disclosure.

FIG. 23A is a perspective view illustrating the quick connect/disconnect system, in accordance with various embodiments of the disclosure.

FIG. 23B is an exploded view illustrating of FIG. 23A, in accordance with various embodiments of the disclosure.

FIG. 23C is a set of generalized views (cross-sectional view, side views, perspective views) of the electronic connect/disconnect system. It is important to note that the electrical connect/disconnect system can be retrofitted into existing connect/disconnect systems or manufactured entirely.

FIG. 23D is a LED layout for the electronic quick connect/disconnect system representing the LED, in accordance with various embodiments of the disclosure.

FIG. 24 is an exploded view representing the first preferred embodiment, an electronic modern nozzle configured to perform the techniques disclosed herein, in accordance with the various spray nozzle embodiments disclosed herein.

FIG. 25 is a perspective view representing the first preferred embodiment, an electronic nozzle configured to perform the techniques disclosed herein, in accordance with the various spray nozzle embodiments disclosed herein.

FIG. 25A is a top view representing the first preferred embodiment, an electronic nozzle configured to perform the techniques disclosed herein, in accordance with the various spray nozzle embodiments disclosed herein.

FIG. 25B is a top view representing the first preferred embodiment, an electronic nozzle configured to perform the techniques disclosed herein, in accordance with the various spray nozzle embodiments disclosed herein.

FIG. 25C is a top view representing the first preferred embodiment, an electronic nozzle configured to perform the techniques disclosed herein, in accordance with the various spray nozzle embodiments disclosed herein.

FIG. 26 is a side view representing the first preferred embodiment, an electronic rear-trigger adjustable nozzle configured to perform the techniques disclosed herein, in accordance with the various spray nozzle embodiments disclosed herein.

FIG. 27 is a side perspective view representing the first preferred embodiment, an electronic adjustable rear-trigger pattern nozzle configured to perform the techniques disclosed herein, in accordance with the various spray nozzle embodiments disclosed herein.

FIG. 28 is a top view representing the first preferred embodiment, an electronic nozzle configured to perform the techniques disclosed herein, in accordance with the various spray nozzle embodiments disclosed herein.

FIG. 29 is a perspective view representing the first preferred embodiment, an electronic wand nozzle configured to perform the techniques disclosed herein, in accordance with the various spray nozzle embodiments disclosed herein.

FIG. 30 is a side view representing the first preferred embodiment, an electronic front-trigger pattern sprayer configured to perform the techniques disclosed herein, in accordance with the various spray nozzle embodiments disclosed herein.

FIG. 31 is a side perspective view representing the first preferred embodiment, an electronic pattern sprayer configured to perform the techniques disclosed herein, in accordance with the various spray nozzle embodiments disclosed herein.

FIG. 32 is a side perspective view representing the first preferred embodiment, an electronic water faucet hose nozzle configured to perform the techniques disclosed herein, in accordance with the various spray nozzle embodiments disclosed herein.

FIG. 33 is a top perspective view representing the first preferred embodiment, an electronic fan nozzle configured to perform the techniques disclosed herein, in accordance with the various spray nozzle embodiments disclosed herein.

FIG. 34 is a front view representing the first preferred embodiment, different electronic nozzle bases configured to perform the techniques disclosed herein, in accordance with the various sprinklers, drip emitters, and oscillator embodiments disclosed herein.

FIG. 35 is a front view representing the second preferred embodiments, different electronic nozzle heads configured to perform the techniques disclosed herein, in accordance with the various sprinklers, drip emitters, and oscillator embodiments disclosed herein.

FIG. 36 is a front view representing the second preferred embodiments, different electronic nozzle bases configured to perform the techniques disclosed herein, in accordance with the various sprinklers, drip emitters, and oscillator embodiments disclosed herein.

FIG. 37 is a front view representing the second preferred embodiment, different electronic nozzle drip emitter heads configured to perform the techniques disclosed herein, in accordance with the various sprinklers, drip emitters, and oscillator embodiments disclosed herein.

FIG. 38 is a front view representing the second preferred embodiments, an electronic nozzle drip emitter head configured to perform the techniques disclosed herein, in accordance with the various sprinklers, drip emitters, and oscillator embodiments disclosed herein.

FIG. 39 is a front view representing the second preferred embodiment, an electronic nozzle drip emitter head configured to perform the techniques disclosed herein, in accordance with the various drip emitter embodiments disclosed herein.

FIG. 40 is a front view representing the second preferred embodiment, an electronic nozzle oscillator configured to perform the techniques disclosed herein, in accordance with the various oscillator embodiments disclosed herein.

FIG. 41 is a front perspective view representing an electronic nozzle case configured to perform the techniques disclosed herein.

FIG. 42 is a block diagram illustrating an adjustment control unit in accordance with one embodiment.

FIG. 43 is a block diagram of one embodiment of the adjustment control unit of FIG. 42.

FIG. 44 is a block diagram illustrating an adjustment control unit in accordance with one embodiment.

FIG. 45 is block diagram of another embodiment of the adjustment control unit of FIG. 42.

FIG. 46 is a flowchart illustrating a method of determining operation/adjustment requirements in accordance with several embodiments.

FIG. 47 is a flowchart illustrating a method of determining operation/adjustment requirements using one or more user entered values of one or more settings variables together with one or more current values of one or more other settings variables from one or more sensors in accordance with several embodiments, as described in the summary.

Like reference symbols in the various drawings indicate like elements.

### DETAILED DESCRIPTION OF THE EMBODIMENTS (FIRST PREFERRED EMBODIMENT): HANDHELD ELECTRONIC NOZZLES

The following figures show handheld electronic nozzles according to the present invention suitable for use with a variety of nozzle heads.

In the simplest form, the handheld electronic nozzle comprises a handle incorporating a trigger, lever, or electronic control operating the main control valve for fluid flow. The handle is secured to a housing for one or more electric motors. The housing is provided with an optional ventilation slot and may be constructed in various sizes and shapes, with a long or short housing, according to the end use garden hose nozzle, handheld outdoor or indoor water faucet, or the like.

By using the electric motors for adjustments versus operational use in some embodiments, battery power is only used while adjustments are being made, and optionally for auxiliary functionality such as lights. A tubular chamber or casing extends from the housing and from the casing projects a retaining connector secured to a drive shaft to be described in this section, in which connector the nozzle is mounted. The chamber is entirely fluid-proof and fluid flows thru the chamber. In addition, for irrigation sprinklers which are adjusted from the top, there are numerous embodiments which are similar in shape as the housing described above that can adjust nozzles from the top of the sprinkler head, and require no additional fittings (built-in-one) so that they may easily adapt to existing sprinkler heads or sprinkler heads of the present invention. In the case of these embodiments, fluid does not get passed thru the housing, since the body sits on top of the sprinkler head, which is ideal for most existing sprinklers today that are top-level adjusted.

The construction of the most simplest electronic nozzle is as follows. An output shaft from the motor is connected into a shaped recess of a subshaft. An end piece secured in the outer end of the drive shaft is externally connected or threaded to receive the nozzle tip retaining collar which surrounds the inner nozzle. The nozzle tip can be a simple adjustable nozzle or as complex as an adjustable pattern sprayer nozzle head. Both require some form of rotation: the pattern sprayer disk (or series of disks) rotate(s) such that the opening differs for each pattern on the pattern disk; the simple adjustable nozzle rotates to either open or close the gap valve opening, proportionate to the rotations required.

The electronic nozzle in spray gun shape may be used for outdoor garden watering use (e.g. adjustable nozzle). It may also be used for sprinklers, as well as, in a smaller form, such as a micro drip emitter or the like. The electronic nozzle may also be used for handheld indoor watering tools such as watering faucets attached to a main fixed faucet, and the like. In general, the operating mechanism of the handheld embodiment differs primarily in shape and scale from that of a sprinkler assembly (sprinkler base, sprinkler head) and in functionality. For example, a sprinkler does not need a trigger or handle, as primary input water flow is determined by the irrigation system control valve controller and timers, although the present invention is non-restrictive in any sense.

In another embodiment, an electric motor within the housing is battery operated and instead of acting on the nozzle irrigation sprinkler controls (such as a pattern disc or simple adjustable nozzle) through the hollow drive shaft with the same centered (or off-center) axis as that with the fluid passing thru, it is placed externally in a separate hollow chamber adjacent to the center fluid tubing of the nozzle for which the separate chamber is attached to either the primary fluid tubing or the housing. This embodiment may increase the overall width of the barrel or cylinder if the size of the fluid tubing remains the same as typical embodiments of sprayer nozzles and sprinklers, etc. The rotation of the shaft is controlled through suitable gearing. A finger-operated set of electronic control buttons is provided and the batteries may be recharged by positioning the electronic nozzle device in a charging base or a case to which is connected a charge unit.

In yet another embodiment, irrigation sprinklers may be made via an extending riser which houses all the electronic controls and includes a housing extension unit. In the case of adjusting sprinkler heads found in prior art, the form only differs in its shape and size and location of the core electronic components.

Whereas the batteries of the electronic nozzle device may be rechargeable, the batteries are readily replaceable by removal of a door on the housing for battery replacement or by removing an enclosure secured by screws or other connection pin mechanisms. It will be understood that it may also be considered more convenient for a motor to be operated by electricity powered from an outlet. A dual power source arrangement is also possible in which power can be used directly from an outlet and a set of stand-by batteries are also provided for short-term use. Various modifications may be made within the scope of the invention as defined in this section and the claims.

Additional adapters and accessories are also assumed in the present invention, such as external lighting in the form of LEDs for nighttime use or visibility (e.g. flashing LEDs to inform pedestrians that a sprinkler is installed at the location), as well as solar panels with nozzle charging built either into the housing or the case that holds the electronic nozzles. For example, a residential user may only be able to water rose bushes while it is dark—either before or after work. In another example, residential or industrial sprinklers may have visibility lighting for landscapes that often have people walking on them at night. In this case, the lighting would be flashing or steady LEDs that display light—similar to other electronic devices such as RC helicopters, RC cars, drones, electric tools, electric shavers, electric toothbrushes, and the like.

Adapters as described above includes a main body that has an assembly and a first coupling portion provided on the top surface of the main body, the first coupling portion having a configuration identical to a coupling portion of the electric nozzle. For example, the light assembly includes a light attached to the main body. The light can be turned on and off independently from the operation of the electric nozzle and houses its own power source module. For example, a sprinkler head may require high visibility in highly walked areas. Another example is lighting where an operator uses the nozzle to wash their car at night, water their garden at night, and so on.

Electronic nozzles come in numerous varieties, with a number of different styles, materials, sizes, spray patterns, flow rates, and more.

Electronic nozzles have two major components—the sprayer head and the handle—each of which can be made out of different material. Electronic spray nozzles can be made completely of metal or plastic, and while others may be part plastic, and part metal.

Metal is generally considered the best material for an electronic nozzle in some cases. Metal nozzles with colorful powder coating or anodized finishes will prevent rusting. Some are covered in plastic or rubber (to protect the electronic nozzle from damage and provide a non-slip grip) and some will have plastic or nylon insulation on the handle. Another is a metal electronic nozzle with a plastic handle. It may be that the working parts inside the nozzle that are most likely to fail so those are the parts that may be made of metal. The preferred embodiment is an all metal nozzle with a rubber or plastic grip.

There are seven major types of electronic nozzles, each with its advantages and disadvantages. The pistol grip that one holds in their hand like a pistol and has an electronic-based lever or trigger to turn the fluid on or off and control the flow rate (e.g. found on the front of the handle, on the back where it's depressed with the palm of the operator's hand, and on top where it's controlled by one's finger), and a nozzle (which may or may not be adjustable) protruding out the front. The dial or turret nozzle has the ability to control an internal disk to adjust the spray pattern or control other parts that can influence the pattern of the spray. The electronic nozzles will have a plurality of spray patterns, including jet, fan or flat, cone, shower, mist, center spray, and soak or flood. The wand is a specialized electronic of the first preferred embodiment nozzle that extends one's reach, and can extend or telescope for added length and includes a cut-off valve or trigger at the base that allows one to start and stop the fluid without having to turn the fluid source off. The fan nozzles emit water in a fan-shaped pattern. The fireman nozzle operates at relatively high pressures. The traditional, cylindrical, or straight nozzle has a straight barrel that internally adjusts to control the amount of water flowing through. The soaker or flood nozzle slowly drips or bubbles out.

Most conventional nozzles have a threaded metal fitting at the end. The electronic nozzle includes an electronics based quick connect system which displays via LED miniature lamps when the connect is secured and when it's partially or fully disconnected and allows the operator to simply snap it on (both the head and the hose). The “male” piece is inserted into the electronic nozzle (or sprinkler as discussed in the second preferred embodiment) via the “female” piece.

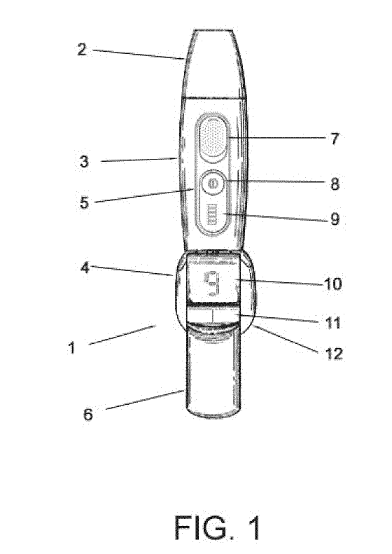

FIG. 1 shows an electronic spray nozzle 1 with an assembly formed from two housing shells 2 and 3, housing 4, trigger 6 fixed on the housing 4, an electronic control/display interface 5, and removable (or detachable) nozzle head 2.

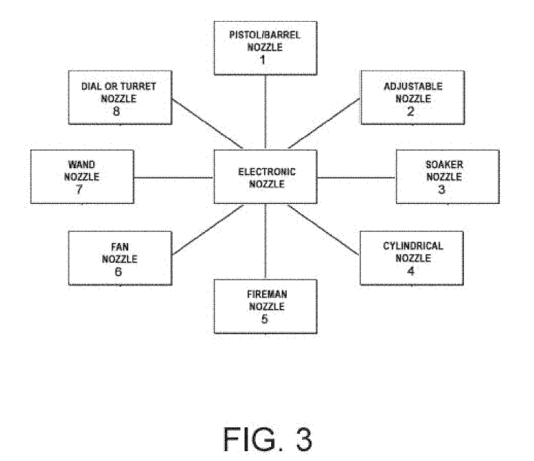

FIG. 3 shows a block drawing of different embodiments of the electronic spray nozzle type.

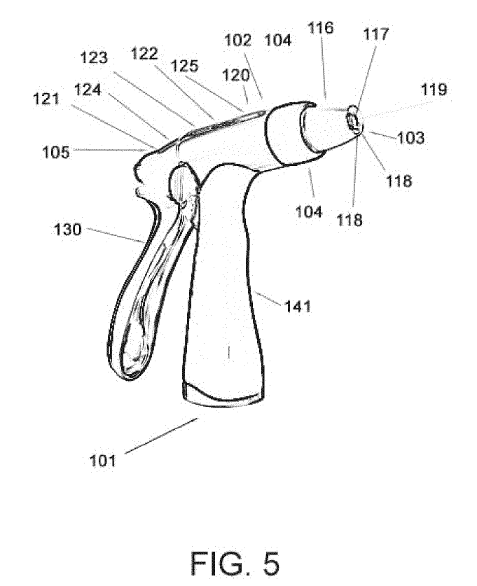

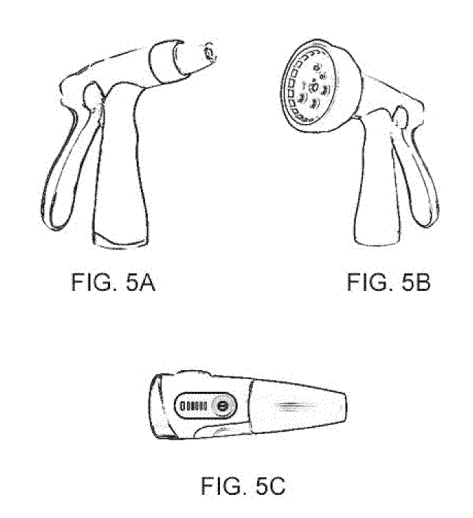

In FIG. 5, an electrically operable nozzle 101 includes a housing 102 having at its upper end a nozzle head 116 that extends in a direction transverse to a central axis 119 and mounts or contains an outlet unit 103 with a central inner nozzle tip 117. An I-Metro “nozzle head” means the interchangeable and detachable/replaceable nozzle tip or nozzle end. The central inner tip 117 is arranged between the housing shell 118 and extends the nozzle assembly and is adjusted to control the flow and pattern of fluid dispensing. The central nozzle tip and the housing shell unit extend on the central axis 119 of the nozzle apparatus 101. The inner enclosure of the nozzle tip housing 108 is not shown in FIG. 5 in the interest of simplicity of illustration. Provided underneath the nozzle tip 118 and the central tip 117 is a cylindrical rotating disk with a hole cutout, not shown in the drawing, which is connected to a drive mechanism of the nozzle apparatus 104.

Arranged in the lower part of the top face is the electronic control interface controls 120: an on/off switch 122, electronic adjustment controls 121, flow/pattern indicators 123, pre-set flow indicators 124, a lock switch to prevent accidental flow 125, and below the on/off switch a charge indicator 126. Other embodiments include charge level indicators, radius, stream type (impulse, rotary, etc.). A recess 105 provided in the top face 104 of the housing 102 extends from the adjustment controllers 121 to the lock on/off switch 120 to the end of the housing 102. Embedded in the nozzle head 116 is an electronic nozzle tip that is substantially comprised of a nozzle tip 117 received in an inner housing 118, and operating controls arranged directly on the top housing control interface 120.

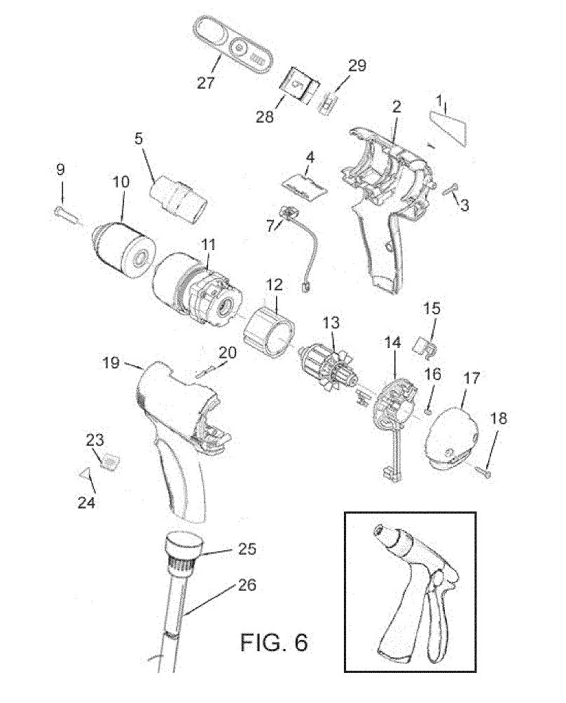

The nozzle tip 116 is illustrated as a single part in FIGS. 6 to 14 and on an enlarged scale as compared to FIG. 5. The size of the nozzle apparatus 101 shown in FIG. 5 is not its real size but is illustrated on a reduced scale.

In keeping with the principle of the present invention, the foregoing object of the present invention is attained by a pistol-type nozzle comprising a hand grip, an electronic barrel, a rotatable spray head, and an electronic trigger. The muzzle of the barrel is provided in the outer wall. The spray head is provided in the inner wall. The spray head is fastened with the muzzle in conjunction with a washer which is located in the groove of the muzzle. The trigger has an electronic press portion which is provided with a cover.

In FIGS. 5A to 5C, different embodiments are shown of an electronic handheld nozzle.

FIG. 6 is shown as an exploded view of some of the key components of a handheld electronic spray nozzle. In FIG. 6, the electrically operable nozzle includes: the name plate 1, the housing set 2, a screw 3, the electronic control and display device assembly 4, the internal fluid chamber 5, the electronic control and device control circuit assembly 7, the nozzle pin 9, the detachable nozzle tip (or head) 10, the gearbox assembly 11, the yoke unit 12, the armature 13, the brush holder 14, the carbon brush 15, the rubber pin 16, the rear cover 17, the screw 18, the housing set 19, the leaf spring 20, the LED flow on/off/partial indicator triangular display 24, a hose connector 25, an external hose 26, the ON/OFF switch, the LOCK/UNLOCK slide switch, the LED flow level bar graph electronic control/display interface 27, the pattern LEFT/RIGHT controls and the LED, OLED or LCD pattern indicator 28 which indicates any combination of preset or customizable nozzle patterns such as Shrub, Flower, Garden, Soft Wash, Clean, Jet, Sweep, and Rinse, and the CHARGE/IN-USE indicator 29.

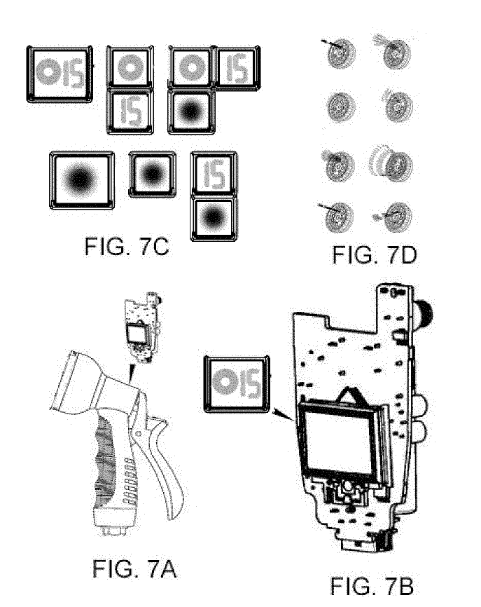

FIGS. 7A to 7D show one embodiment of the electronic control/display interface for water flow pattern. FIGS. 7A to 7D are front perspective views of a LCD display interface which displays the current flow pattern(s) that is(are) currently selected by operator, contained within the adjustable electronic pattern-turret-type nozzle. FIG. 7A is a side view of a short body electrically operated nozzle with an adjustable nozzle head attached to the body. The exploded part of the assembly is the LCD display interface. FIG. 7B is a perspective top view of a LCD interface assembly for displaying the current flow pattern(s). FIG. 7C contains variations of electronic displays such that the current flow (and next/previous flow pattern) can be displayed on LCD interfaces for the present invention. There are many variations, such as a touch screen for a complete list of variations in a larger LCD panel whereby an operator can simple press the preset configuration of his/her choice. FIG. 7D is block view of 8 pattern nozzle flow patterns, which can be represented in a LCD interface. In 7D the internal adjustable electronic turret patterns are as follows: Center, Mist, Cone, Shower, Angle, Flat, Soaker, and Full.

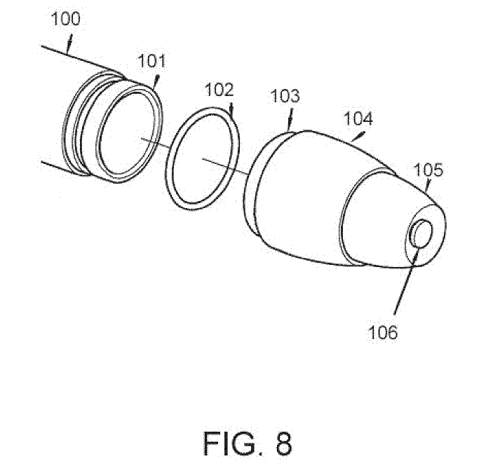

FIG. 8 shows a perspective view of an adjustable nozzle attachment of the present invention. As shown in FIG. 8, an adjustable nozzle head 104 of the present invention is fastened with the housing 100. The electronic nozzle body 100 is provided in the wall connection 101. The electronic spray head 104 is provided with a connection end 103 and is further provided in the inner wall in proximity of the connection end 103. The connection end 103 of the electronic spray head 104 is joined with the body 101 in conjunction with a washer 102 which is located in the hole of the body connection 101. The electronic spray head 104 and the body 100 are held together by various methods, including magnetism (not shown). In the process of joining the connection end 103 of the electronic spray head 104 with the connection 101, the retaining projection 103 of the electronic spray head 104 is inserted into the connection 101 of the electronic body barrel 100. We expect various embodiments will include miniature LEDs that illuminate various colors depending on the connection state. For example, if the nozzle head is unsecured, it will illuminate in red; if connected, it will illuminate in green; if partially connected, it will illuminate in yellow. We also expect various connection mechanisms such as interlocking mechanisms, standard threaded mechanisms, in addition to electromagnetic methods for connecting spray heads to nozzle body components of this present electronic invention of the spray head nozzle for sprinklers, garden hose nozzles, water faucet nozzles, and the like.

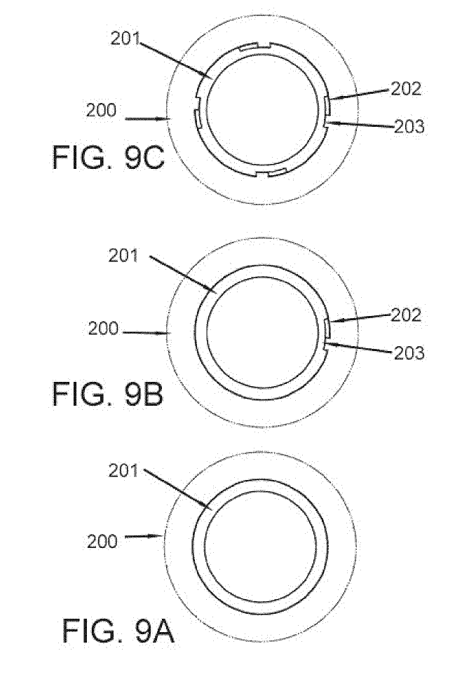

The spray head 200 and the body 201 are held together by the retaining projections 203, which are securely located in the retaining portion 202 of the retaining slot such that the retaining projections 203 are arrested by the retaining ridge 202 of the retaining portions, as illustrated in FIGS. 9B and 9C. In the process of joining the connection end of the spray head with the muzzle -, he retaining projections of the spray head are inserted into the retaining slots of the muzzle via the guide portion of the retaining slots, similar to a tongue and groove joint which is used for re-entrant connections. This type of method has been used over many years of inventions since man-made products have been made in industrial periods of any civilization where connections are made by fitting similar objects together, edge to edge. FIG. 9A can be any type of connection such as standard threaded connection or magnetic connection.

In a generalized embodiment of the electronic coupler system, the male connector, includes an electronic connection system that connects the female connector to the male connector. The electronic connection system includes a first electronic element associated with the male connector and a second electronic element associated with the female connector. The electronic elements are connected to each other to connect the male connector to the female connector via an electronic method (such as electronically-controlled rotation or electronically-controlled locking/unlocking bar/pin/slot/shuttle movement). The present invention offers various embodiments of connectors, depending on the type of nozzle. Whenever a connection has been made, the coupler system displays a flashing or steady signal.

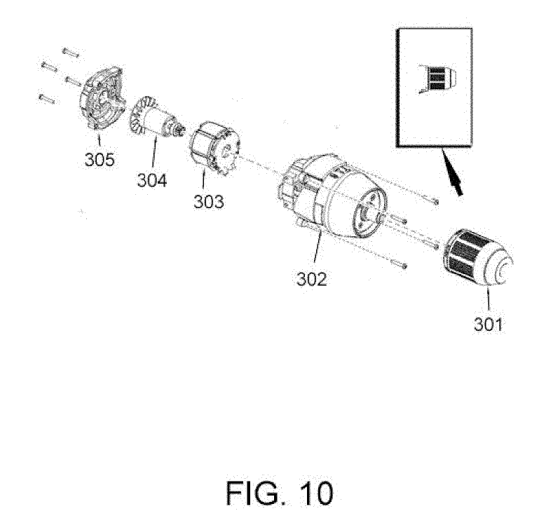

FIG. 10 is an exploded perspective view of the operating adjustable motor and transmission of the adjustable nozzle. The rotating drive shaft 301 which mounts a nozzle head or turret pattern disk is connected to the gear case assembly 302 which is connected to the electric motor 303, which, in turn, is connected to the service armature 304 which is mounted to the rear cap 305 of the housing.

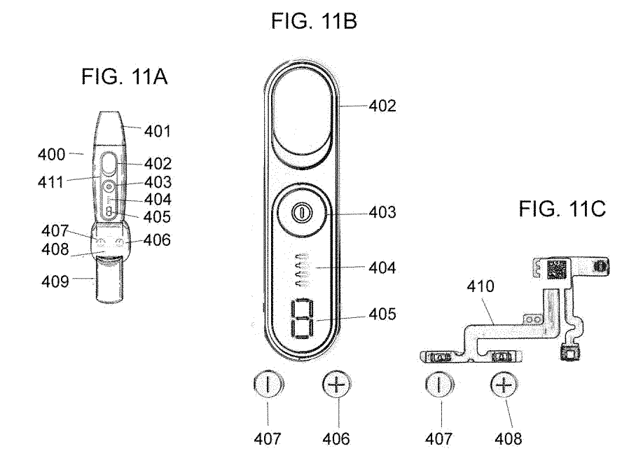

FIG. 11A is a two-dimensional top view representation of a handheld electronic spray nozzle according to the invention shown from the back to the front of the nozzle, wherein the electronic control devices reside on the top of the nozzle. The head 401 is connected to the main body housing 400. The electronic control device 411 includes the lock/unlock switch 402, the power on/off/standby switch 403, the LED bar graph indicator of fluid flow 404, and the pattern indicator 405. The +/− flow and pattern adjustment buttons resides on the top of the handle 408. The rear-trigger is connected to the handle 409 of the body 400.

FIG. 11B is a top view representation of an electronic control/display device of the handheld electronic spray nozzle. The electronic control device 411 includes the lock/unlock switch 402, the power on/off/standby switch 403, the LED bar graph indicator of fluid flow 404, and the pattern indicator 405. The +/− flow and pattern adjustment buttons 407 and 408 reside on the top of the handle (not shown).

FIG. 11C is a top view representation of the fluid flow electronics for increasing and decreasing the flow, as well as for adjusting the nozzle head. The decrease water flow/rotate left button 407 and the water flow/rotate right button 408 is connected to the circuitry 410 for controlling fluid flow and adjustments to the nozzle.

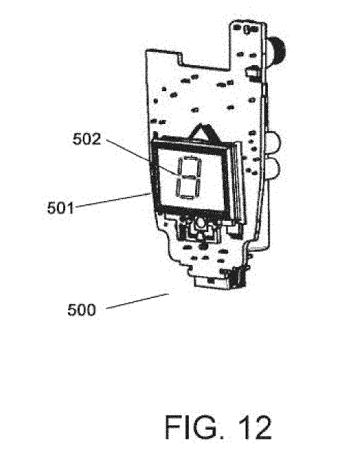

FIG. 12 is the perspective view of the LED display for the pattern indicator. The panel 502 is mounted to the LED display case 501 which is mounted to the electronics for displaying the pattern that the nozzle is currently holding.

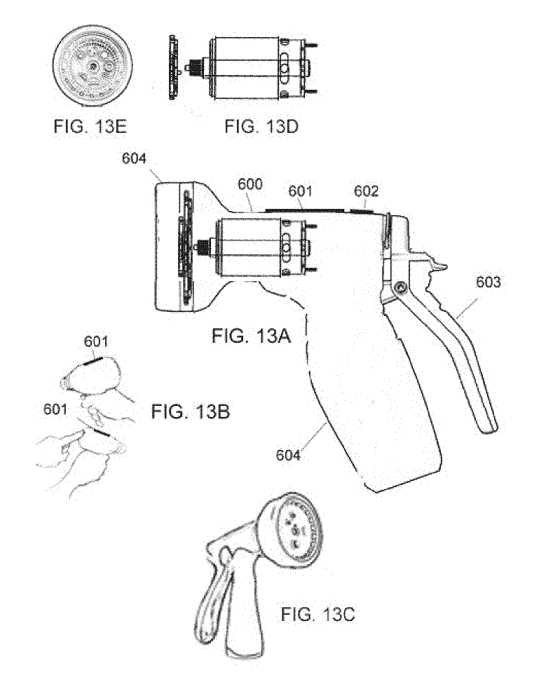

FIG. 13A is the side view of the electronic pattern nozzle with LED display and controls for the pattern indicator. The panels 601 and 602 are mounted to the nozzle body 600 which contains the electronics for controlling and displaying the pattern for the nozzle. The rear-trigger 302 is to open and close the input valve. In FIG. 13B, there are two representative views of the electronic nozzle being operated and adjusted using touch controls 601 which control the operation and adjust the settings. FIG. 13D is a side view of the transmission with drive shaft of the first preferred embodiment of the pattern nozzle. FIG. 13E is a front view of the electronic pattern nozzle attachment which connects to the transmission drive shaft. The fluid flows through the housing of the transmission drive shaft. It is noted that the pattern can take on numerous flow cutouts, including custom 3D printed patterns that can be configured by the electronic preset configuration control device and stored into memory by the processor of the microcontroller—that is, the electronic spray nozzle can offer a countless number of different N spray pattern disks for the operator's specific needs.

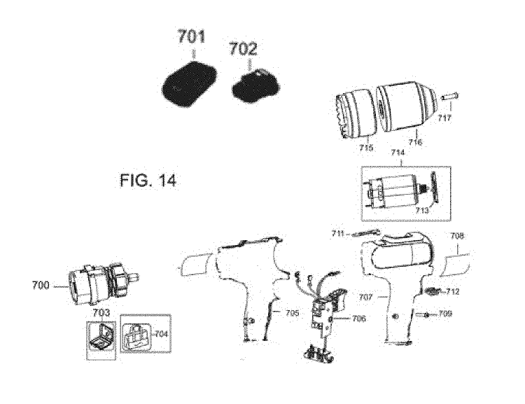

FIG. 14 contains a perspective view of varying scale that illustrates various key components of the present invention. The charging case 701 charges detachable battery power source module 702. 700 is the transmission assembly. 703 is a hard carrying case for the electronic nozzle and 704 is a carry case. The outer housings 705 and 706 are two parts which are fastened together. 706 contains electronic circuitry and actuator for electronic control of an electronic variable force solenoid. 732 is the electronic control device for setting adjustments setting the nozzle on/off/standby, and locking the nozzle, and displaying various indicators. 735 is a pattern plate which can be replaced with another pattern plate of an operator's choice. 734 is an electric motor which controls the adjustment setting of the pattern nozzle. 716 is a connector for the rotary adjuster for the pattern disk or plate. When powered on, the electronic nozzle can rotate the pattern disk to the appropriate flow opening via the electronic control device 711 which is mounted onto the 705/706 housing seat. The hard carrying case 703 may contain a built-in charging assembly similar to 701 which can charge the rechargeable batteries while the electric nozzle is stored in the case. The electronic nozzle as shown in FIG. 14 can connect a plurality of nozzle attachments which are most suitable for the form as shown.

### Detailed Description of the Embodiments (Second Preferred Embodiment): Sprinklers, Oscillators, Drip Emitters, and the Like

Typically, when one is choosing sprinklers, oscillators, drip emitters, and the like, one identifies normally shaped areas, oddly shaped areas, and borders as well as sections that may need less water than others (for example, shrubs and trees require less water than grass and flowers). Today, it's easier to adjust heads to reduce spray distance than it is to dig them out and reinstall them if spray falls short, so an operator typically installs on the side of caution and keeps them close. Different types of sprinklers have different flow rates, so typically one installs only one kind in a given zone. Sprinklers have different patterns, including square for clearly defined landscapes and triangle patterns for irregularly shaped landscapes. Different types of sprinkler heads come with various features, such as spring retraction, drip irrigation or the ability to water a special pattern. When one needs to irrigate small ground cover areas, narrow beds and compacted, slow-absorbing soils, one typically utilizes micro spray heads that provide patterns and flow rates suited for these purposes. Spring retraction sprinklers ensure that pop-up sprinklers return to their underground position automatically as soon as they finish their cycle, rather than relying on gravity to do the work. In areas of landscapes that conventional sprinkler heads can't quite get to or may prove too powerful for, such as hanging shrubs or delicate gardens, one typically installs a drip irrigation system. Drip systems provide slow, steady water in hard-to-reach places without damaging plants and flowers. There are numerous types of sprinkler heads: rotary heads, spray heads, bubblers, and so forth. A fixed spray produces a tight, constant fan of water. A flood/bubbler sprinkler head produces a flow of water that soaks soil to reach the root zone, A gear driven sprinkler head provides for smooth, quietly operating heads that often feature manually adjustable patterns. A multiple stream produces thin streams of water that slowly rotate in a radius. A pop up sprinkler head pops above grass when activated and disappear below ground when not in use, which provides even water distribution and low spray angles. A rotary sprinkler delivers a single stream of water that rotates in a circle and applies water more slowly than spray designs. A special pattern nozzle sprays a special pattern that provides flexibility.

The present invention provides electronic and electromechanical means for adjusting the pattern, the type (rotor, pop-up, impulse, etc.), the angle, the radius or the distance of throw, the arc, the flow rate, and so forth. One clear advantage of this approach is that a user can install an electronically adjustable sprinkler head and not have to replace it if the watering requirements change. For example, a user may install or remove plants, shrubbery, grass, and so forth, and therefore require a change in sprinkler head adjustments, flow rates, patterns, types, and so forth. The user can simply change the settings remotely or at the locations of the sprinklers with ease without having to use special tools in order to fine tune the adjustments manually. The present invention has the adjustment functionality built into the unit. This invention also makes it possible to change the type, pattern, and so forth electronically without having to purchase new heads whenever requirements change.

In particular, one embodiment of the present invention includes an irrigation sprinkler having a riser assembly that includes a rotatably mounted electronic nozzle head (or “turret”), which can be adjusted locally at the sprinkler or remotely via a base station or a smartphone (which communicates to either a base station or an Internet server). An electronic drive assembly is mounted in the riser assembly that couples the drive mechanism, a turbine and the nozzle turret. The improvement over existing sprinklers is that the electronic drive mechanism can electronically control the adjustment parameters and patterns and type from the riser assembly or remotely via a remote control, a base station, a control unit, a controller, an Internet application, a smartphone or pad app, and so forth.

Today, in prior art, there are sprinklers with secondary nozzles either contained within a sprinkler head (or turret) or within a port mounted on the primary nozzle. The nozzle turret carries a removable portion where secondary nozzles can be installed. The purpose as stated by the inventor is to place a secondary nozzle in a rear facing direction so that the secondary nozzles spray water in an opposite direction to that sprayed by the primary nozzle which allows the water being emitted from the secondary nozzles to at least partially offset the forces of the water being sprayed from the primary nozzle to reduce the significant side forces on the sprinkler. The present invention improves upon this multi-nozzle concept by allowing dynamic real-time control of the sprinkler heads in order to alter their adjustments. For example, one embodiment of the present invention is an integration adaption kit for existing sprinkler heads offered by manufacturers today to make it “smart” and electronically controlled. Another embodiment of the present invention is an adaption module for irrigation controllers so that operators can make finer adjustments from an irrigation controller, base station, Internet application, or mobile app. So while recent inventions have allowed the user to easily change the secondary nozzles at different times of the seasons, the present invention allows operators to change the type, pattern, arc, radius, flow rate, etc. without having to manually adjust or change or alter the existing overall sprinkler system. For instance, conditions and materials may not require irrigation throughout an entire year and this invention allows for the same sprinklers to be re-adjusted according to the needs of the operator on an ad-hoc or even scheduled basis.

Solar power offers the ability to re-charge the sprinkler heads or garden hose nozzles on a daily basis, but the operator can also replace the batteries or charge the nozzles using a charging station at the comfort of their own home, office, or other location, using this present invention.

Most sprinkler models, adjust the same way and utilize the adjustment tools provided by the manufacturer. For example, all Hunter Rotor models, according to their website, including the PGM, SRM, PGJ, PGP, PGP Ultra and I-20, adjust the same way and utilize the same adjustment tool, using the Hunter wrench. Toro, Rain Bird, Orbit, and other manufacturers have similar adjustment procedures in operation today, along with similar tools. Adjustable heads are typically first preset to manufacturer settings. Sprinklers then may be adjusted with water on or off and it is highly recommended that initial adjustments be made before installation. The first step typically involves the following, according to a leading manufacturer today: “Using the palm of one's hand, rotate the nozzle turret counterclockwise to the left stop to complete any interrupted rotation cycle. The operator then rotates the nozzle turret clockwise to the right stop. This is the fixed side of the arc. The nozzle turret must be held in this position for arc adjustments. The right stop does not change. To increase the arc of any Hunter rotor sprinkler, one inserts the plastic key end of the wrench into the adjustment socket and while holding the nozzle turret at the right stop, one turns the wrench clockwise. Each full 360° turn of the wrench will increase the arc 90°, according to specifications and the any arc can be adjusted between 40° or 50° and 360°. The wrench will stop turning, or there will be a ratcheting noise, when the maximum arc of 360° (full circle) has been reached. To decrease the arc, one inserts the plastic key end of the wrench into the adjustment socket and while holding the nozzle turret at the right stop, one turns the wrench counterclockwise. Each full 360° turn of the wrench will decrease the arc 90° and the arc can be adjusted between 40° or 50° and 360°. The wrench will stop turning, or there will be a ratcheting noise, when the minimum arc of 40° or 50° has been reached. To adjust the radius or distance of throw, one inserts the steel hex end of the wrench into the Radius Reduction Screw. By turning the screw clockwise, the radius is decreased by counterclockwise turning, the radius can be adjusted. Radius can be reduced up to 25%.”

As another example, the Rain Bird Simple Adjust Series Rotors adjust as follows: “Find and set the fixed LEFT edge. Turn the center cap of the rotor all the way to the right until it stops. Then turn it to the left until it stops. This is the fixed left edge. Rotate the entire rotor case to align the left edge into the correct position. This is the starting point from which water rotation will begin. Do not force the rotor past the fixed left edge as it may strip the internal gears. For adjusting the arc pattern, the arc is preset to rotate 180° or a half circle. Using a flat-bladed screwdriver, turn the arc adjustment screw clockwise (+) to increase the arc or counterclockwise (−) to decrease the arc. The pattern is adjustable from 40° to 360°. These adjustments can be made while the water is on or off. In order to adjust the spray distance: With the water on or off, one can adjust the distance of throw. Using a flat-bladed screwdriver, turn the radius reduction screw to decrease the spray distance up to 25%.”

The present invention provides a plurality of electromechanical mechanisms for the rotations of shafts in order to raise and lower valve closure elements and increase or decrease the flow area of outlet slots. Conventional (or traditional) spray nozzles for sprinklers often include one or more small screws at the top of the head that can be turned with a screwdriver or wrench to adjust the flow rate and arc, which can also adjust the reach or radius to some degree. The present invention provides for an electromechanical mechanism and is configurable to fit most models that exist on the market today that are currently adjusted via mechanical means. The present invention is also intended to rotate a nozzle ring in order to enlarge the orifice. In this alternative arrangement, the adjustable patterns may be fixed to produce a set pattern. The size of the pattern may, of course, be reduced by adjustments. Rotation of rings relative to other rings on the stop assembly will vary the arc of coverage of the stream and thus vary the sprinkling pattern, as desired.

A rotary sprinkler head is rotatably mounted within the base, and cooperates with the stream deflector to define an arcuate water discharge orifice. The nozzle is operatively connected through a drive mechanism to an arc adjustment ring mounted on the top of the base, and externally accessible to the user. Thus, the electronic adjustment mechanisms may rotate an arc adjustment ring to lengthen or shorten the arcuate length of the discharge orifice. The arc adjustment ring, for example, may be rotated also to loosen and effect removal of dirt lodged in the nozzle, without otherwise altering the arc of coverage.

It is a related object of this invention to provide sprinklers, drip emitters, and oscillators as described above.

### Figures of Second Primary Embodiment

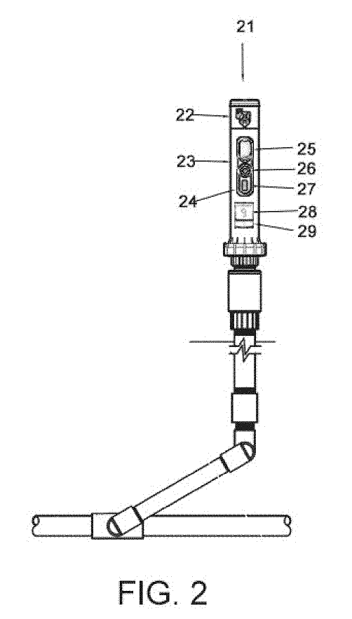

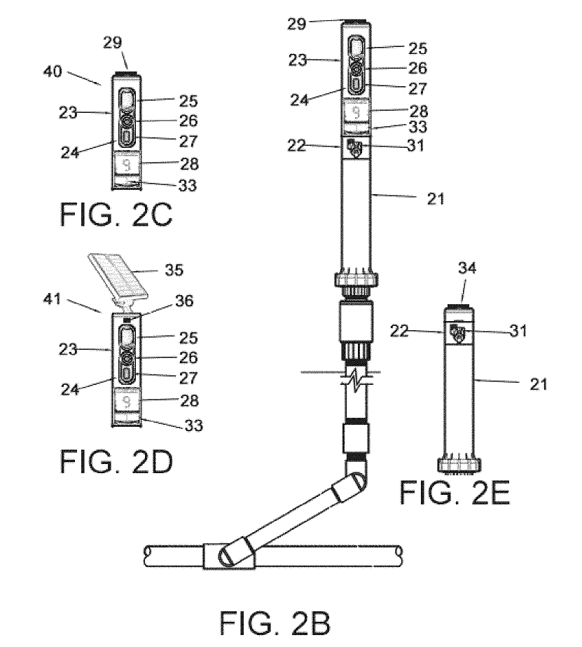

FIG. 2 shows an electronic sprinkler nozzle 21 with an assembly formed from two housing shells 22 and 23, housing 24, an electronic control/display interface 25, and removably arranged nozzle head 22. FIG. 2B shows another embodiment of an electronic adjustable sprinkler nozzle (or head) 21 with an assembly formed from two housing shells 22 and 23, housing 24, an electronic control/display interface locking mechanism 25, a removably arranged nozzle head, a power on/off switch 26, a LED flow level 27, a pattern/type indicator 28, and +/− controls 31.

FIG. 2C shows another embodiment of an electronic adjustable sprinkler nozzle (or head) 21 with an assembly formed from two housing shells 22 and 23, housing 24, an electronic control/display interface locking mechanism 25, a removably arranged nozzle head, a power on/off switch 26, a LED flow level 27, a pattern/type indicator 28, and −/+ controls 31. In this embodiment the body 23 resides on top of the nozzle head, whereas in FIG. 2, the embodiment resides below the nozzle head in the riser/extender of the sprinkler. On top of the sprinkler, there is also a flashing or steady LED subsystem 29 for lighting purposes to indicate to pedestrians that there is a sprinkler installed.

FIG. 2D shows another embodiment of an electronic adjustable sprinkler nozzle (or head) 41 with an assembly formed from two housing shells 22 and 23, housing 24, an electronic control/display interface locking mechanism 25, a removably arranged nozzle head, a power on/off switch 26, a LED flow level 27, a pattern/type indicator 28, and −/+ controls 31. In this embodiment the body 23 resides on top of the nozzle head, but is detachable and used for sprinkler adjustments. On top of the sprinkler, there is also a tiltable solar panel 35, and a flashing or steady LED subsystem 36 for lighting purposes to indicate to pedestrian that there is a sprinkler installed.

FIG. 2E shows an electronic detachable sprinkler flashing or steady LED subsystem 34 for lighting purposes only to indicate to pedestrians that there is a sprinkler installed.

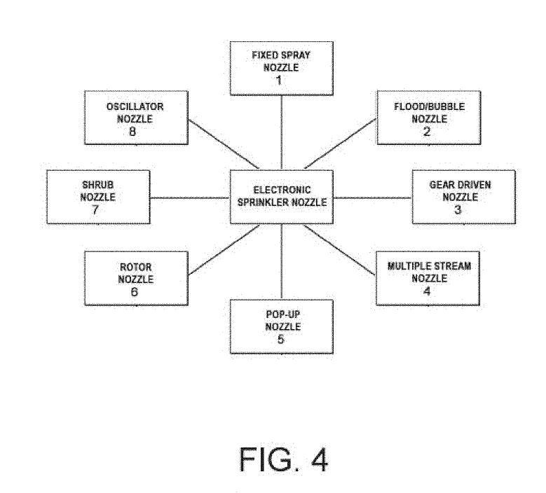

FIG. 4 shows a block drawing of different embodiments of the electronic sprinkler nozzle.

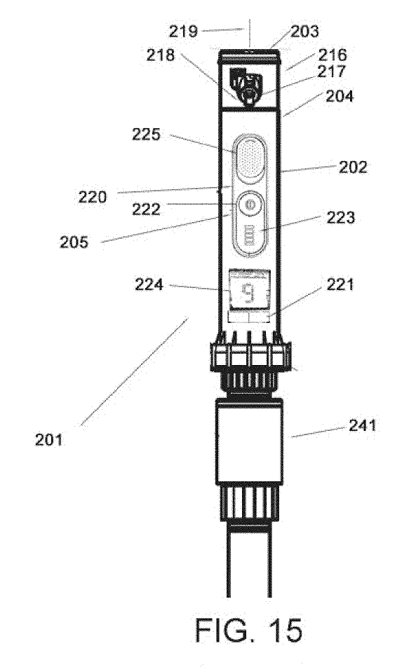

FIG. 15 is shown as a front view of some of the key components of the sprinkler spray nozzle. FIG. 15 pertains to electronically adjustable sprinkler nozzle and is capable of adjusting adjustable features of sprinkler today on the market by attaching assembly on top of the head of an existing sprinkler. This includes adjustment of the deflector spray angle, the flow, the arc, the distance or radius of throw, and so forth. Sprinklers are typically pre-set at the factory, but can also be adjusted in the field by screw drivers and by rotation of rings, etc. FIG. 15 illustrates an electronic adjustable nozzle, in which the spray arc and distance is adjusted by rotation of screws. When these screw heads are rotated by the present invention, the arc and distance (radius) are adjusted. In FIG. 15, an electrically operable sprinkler 201 includes a housing (“case”, “body”, “riser”) 202 having at its upper end a nozzle head 216 that extends in a direction transverse to a central axis 219 and contains an outlet unit 218 with a central inner nozzle tip 217. An I-Metro “nozzle head” means the interchangeable and detachable/replaceable nozzle tip or nozzle end.

Arranged in the lower part of the top face are the electronic control interface controls 220: an on/off switch 225, electronic adjustment controls 221, flow/pattern indicators 223, pre-set flow indicators 224, and a lock switch to prevent accidental flow 225. Other embodiments include charge level indicators, radius, stream type (impulse, rotary, etc.). A recess 205 provided in the top face 204 of the housing 202 extends from the adjustment controllers 221 to the lock on/off switch 225 to the top of the housing 202. Embedded in the nozzle head 216 is an electronic nozzle tip that is substantially comprised of a nozzle tip 217 received in an inner housing 218, and operating controls arranged directly on the top housing control interface 220.

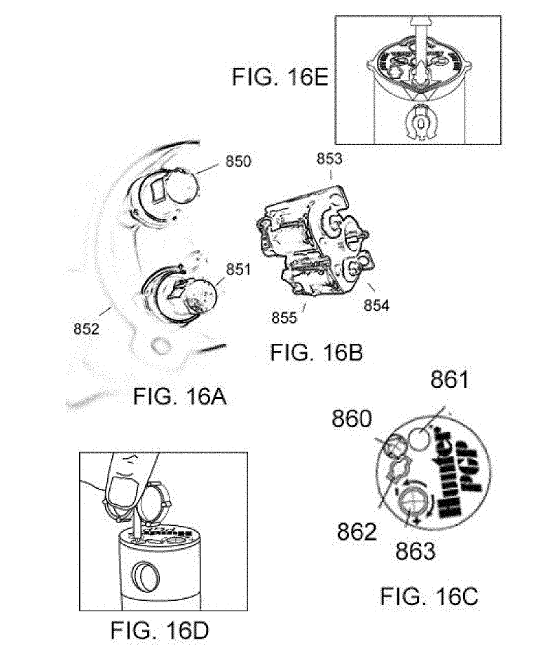

FIGS. 16A to 16E pertains to an electronically adjustable sprinkler nozzle attachment which is capable of adjusting specific sprinkler manufacturers. According to the manufacturer's manual, arc adjustment, requires rotating the manufacturer's wrench clockwise and counterclockwise. To adjust the radius (or distance of throw), the steel hex end of the wrench is inserted into the radius adjustment screw and turned clockwise (into the water stream) to decrease the radius, and counterclockwise to increase the radius.

FIG. 16C to FIG. 16E is prior art of a top adjustment assembly from a leading sprinkler manufacturer. The present invention is illustrated in FIGS. 16A and 16B. In FIG. 16A, there are two rotating drive shafts 852 capable of rotating adjustment 863 and 860 via drive shaft 850 and drive shaft 851. In FIG. 16B, a twin motor 855 is illustrated which consists of two drive shafts 853 and 854 that are capable of adjusting the adjustable members 860 and 863 in FIG. 16C. The twin motor is controlled via the electronic control interface as well as via an Internet application, a base controller, a base control unit, and/or a smartphone app via the communications module (not shown) of the microcontroller assembly.

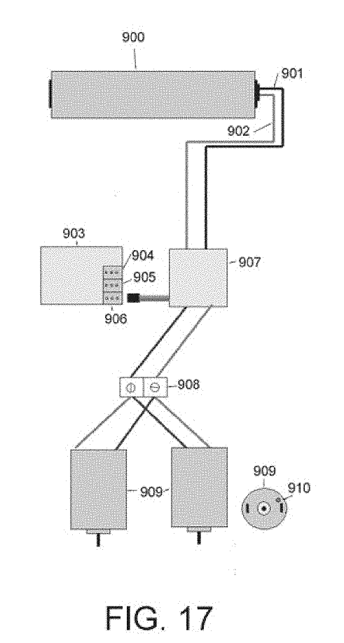

FIG. 17 illustrates the electronics for the twin motor assembly of FIGS. 16A and 16B. The battery module 900 has two leads 901 (negative) and 902 (positive) which is connected to the electronic speed/power controller 907. The speed controller 907 receives commands from the electronic controller which connects the power 904 and Channel 1 (905) and Channel 2 (906). These connect to the electric motors (909) via the Connector Block (908). The positive mark terminal plugin 910 indicates to the electronics technician during assembly or repair the positive terminal for the electrical motor 909.

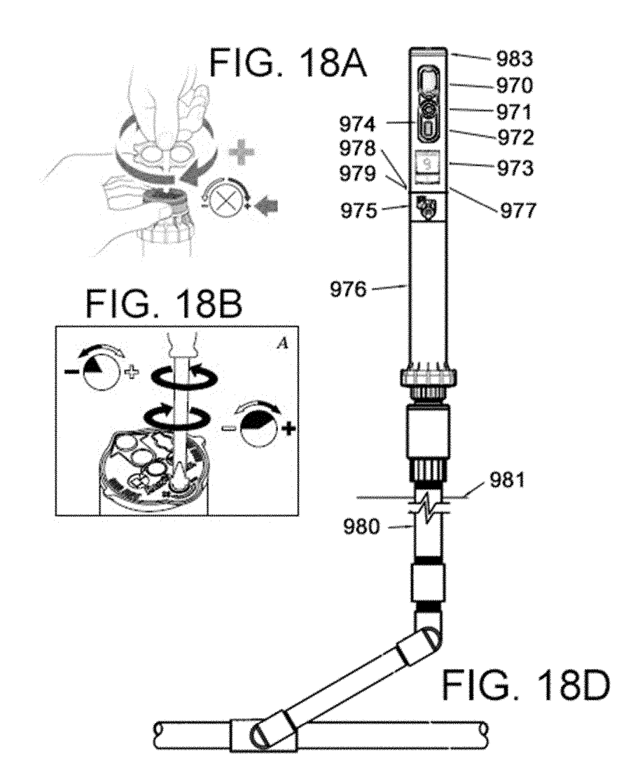

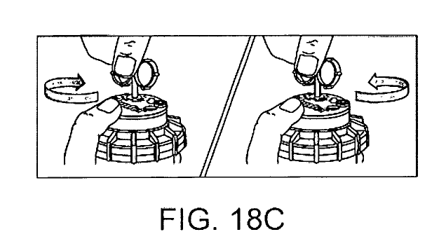

FIGS. 18A to 18C illustrate how adjustments are currently made by leading manufacturers. FIG. 18D contains the second preferred embodiment as an adapter assembly, which adjusts a manufacturer's sprinkler assembly. As shown in FIG. 18, the electronic control and display interface includes the lock/unlock mechanism 970, the power on/off/standby switch 971, the flow indicator 972, the configuration indicator 973 which displays the current configuration (e.g. arc, radius, and so forth, depending on the mode), and the +/− adjustment controls 977. The spray head 975, which resides above the manufacturer's sprinkler riser case 976 that is connected to the body 980, is adjusted via the top assembly, via the controls and a plurality of electric motors as detailed in FIGS. 17, 18D, 16A and 16B. The adjustment screws (978,979) for arc and radius are housed within the spray head which are adjusted via electromechanical means within the top assembly. The screws 978 and 979 are replacement screws designed to best accommodate for the tool bits of the present invention. The microcontroller can accept commands via a remote control, a base controller, a base control unit, an Internet application or a smartphone app. This same technology can be housed within a riser or body component if used as a standalone solution for electronic control via remote modules or on-board from a craft interface.

The craft interface allows the operator to view status, adjustment settings information (such as arc, radius, direction, angle, flow rate, arc, and other adjustable aspects of the system), troubleshooting information at a glance and to perform various system control functions. It is hot-insertable and hot-removable from the actual spray head. The craft interface is located on the side or on top of the spray head and contains LEDs, LCDs, and/or electromechanical controls (such as knobs, sliders, etc.) for controlling the various electromechanical components, the mechanical contacts, and even in some embodiments may house an on/off switch for the control valve(s) of the sprinkler.

The electronics provided on the body of the present invention may be viewed as a craft user interface that would typically be used by the field personnel, homeowners, and the like, as it is today for mechanical adjustments—however, the craft interface is built-into the housing and does not require additional tools as seen in prior art. For initial provisioning tasks, the sprinkler (or oscillator, drip emitter, etc.) name, location, current date and time can be entered into an application. The software controller is a graphical user interface tool that is used to provision the sprinkler. The controller converts user input into corresponding language commands accepted by the on-board microcontroller via the IoT communications module. The software controller would typically be used by an operator to provision the adjustments. The information includes the name for the sprinkler and the node location (which may include the latitude and longitude or other identifying geographical information). Each node will have specific components and actions can be performed on each component, such as decrease arc, increase arc, increase radius, decrease radius, and so forth.

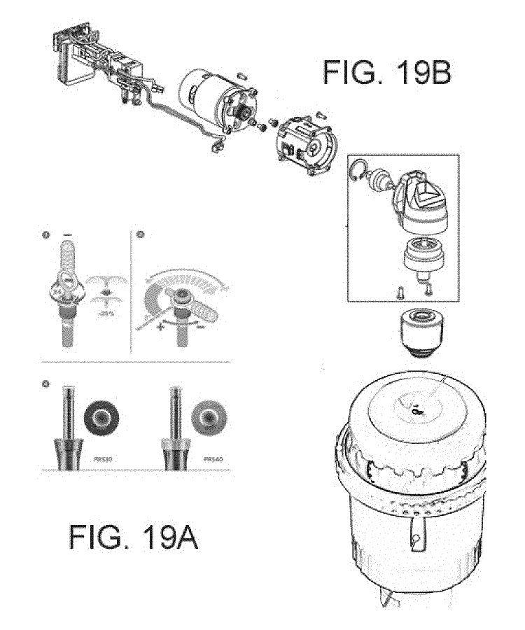

In FIGS. 19A to 19B, the present invention adapts to multiple rotating stream spray heads which feature a multi-trajectory rotating stream delivery system that deliver streams of water at a steady rate. The present invention can adjust the arc and radius via similar mechanisms as previously discussed within this invention. The spray head adapter of the present invention can be installed onto the new rotor spray head, as well as the conventional spray head body or shrub adaptor. FIG. 19B illustrates this—it can operate at a right angle (similar to right angle drills).

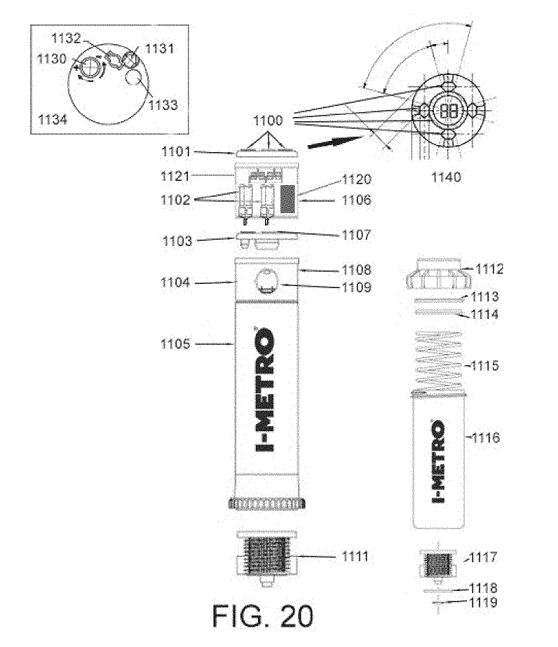

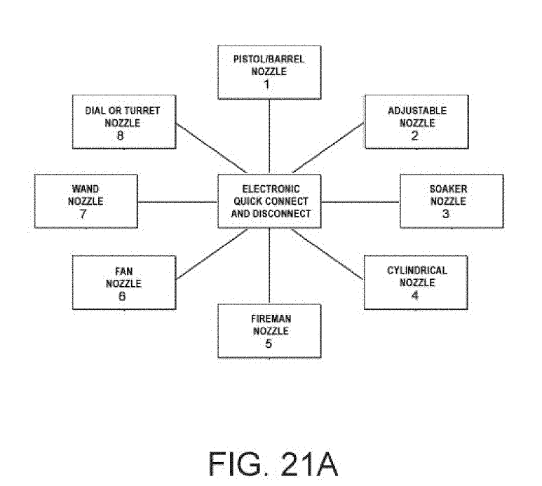

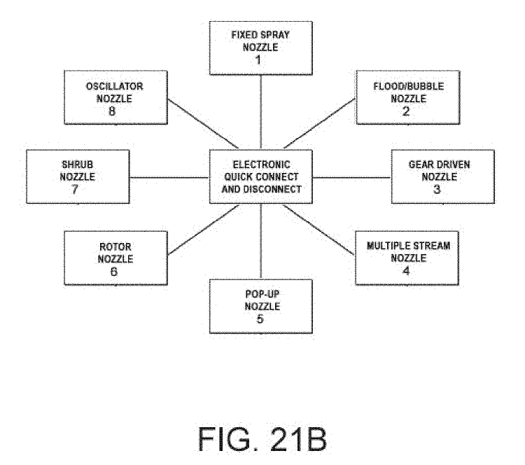

FIG. 20 illustrates details of the nozzle system of the second preferred embodiment of FIG. 2. The electronic user control/display interface 1100 and cover 1101 is vertically situated on top of the controller housing 1121 which contains the electronics and mechanical mechanisms of the present invention. The electric motors adjust the adjustment screws that are recessed in the protective rubber cover 103 which covers the spray head 1104. The spray head 1104 contains the nozzle 1109 in the body 1108. The spray head is fastened to the riser assembly 1105. The electronic control assembly 1140 contains the electronic control interface that includes power on/off/standby switches, flow, angle, arc, radii indicators, up/down/+/− buttons and so forth. In the adapter version of the second preferred embodiment, the adapter controls a manufacturer's adjustment settings for arc 1130 and radius (i.e. nozzle range) 1131.

Another object of the present invention is to reinvent prior art by providing the unique and new ability to electromechanically control the amount of water flowing at various arc and radius settings, as well as offer on/off control. Prior art does not afford the ability to support a larger range of radiuses at which each is offered, whereas the present invention offers the ability to go from the minimum radius in the industry to the maximum radius than that which is offered today. Manufacturers typically offer it in incremental sizes. Since the present invention can electromechanically operate, providing various sizes at incremental levels is no longer necessary for a particular general size (i.e. from miniature size to standard size to oversize models). One of the key objects of the present invention is to provide electromechanical adjustment support for any existing standard sprays and side-striped specialty nozzles and offer a complete replacement version that has the technology of the present invention (i.e. an electronic adjustable nozzle system).

### Electronic Nozzle Quick Connects

The electronic connectors for both body-to-head and body-to-hose (or body-to-pipe) may be structured and formed in a variety of different ways. In one example, the electronic quick connect/disconnect system may be formed with an integrated external locking body or frame for receiving a male connecting member in a mechanical manner. In another example, an electronic quick connect/disconnect system may be formed with a locking/unlocking mechanism that uses electronic connect/remove methods. Each example provides an electronic or mechanical locking/unlocking mechanism and an electronic display unit (one or more LEDs assemblies). A primary feature of this portion of the invention is an electronic display of operational status (connecting, connected, disconnecting, disconnected).

In a generalized embodiment of the electronic coupler system used in the electronic adjustable nozzle system, the male connector, includes an electronic connection system that connects the female connector to the male connector. The electronic connection system includes a first electronic element associated with the male connector and a second electronic element associated with the female connector. The electronic elements are connected to each other to connect the male connector to the female connector via an electronic method (such as rotation or locking/unlocking bar/pin/slot/shuttle movement). Whenever a connection (and electrical contact) has been made, the coupler system displays a flashing or steady signal for a period of time. Whenever a disconnection occurs, the coupler system displays a flashing or steady signal for a period of time. The coupler system also may display connection directional arrows such as when a connection is occurring, and so on, as it is easy to detect contact as the connection is engaging thru additional contact mechanisms within the circuitry of this portion of the present invention.

<Feedback from Connectors when Connected>

In this invention of the electronic nozzle and its underlying subcomponents, a flashing or steady signal may be displayed on the display unit to indicate different operational statuses of the connection. Not every status requires having a flashing or steady signal. For example, the display unit may only display a disconnected status via a flashing or steady red signal and not display any signal when connectors are mated in order to preserve power. A mode selector switch can be optionally provided with the system that an operator purchases that allows for the operator to select various display mode conditions (e.g. always on, on for a preset period of time, and so forth).

<How the Electronic Quick Connect/Disconnect System Works>

1—Case The tube that houses the parts of the electronic display unit, including the lamp (light emitting diodes).

2—Contacts A very thin spring or strip of metal (copper or brass) that is located throughout the connector, making the electrical connection between the various parts—the batteries housed within the nozzle body, the lamp (LEDs), and the switch on/off of the electronic nozzle body. These parts conduct electricity and “hook everything up,” completing the circuit.

3—Switch The flow of the electricity is activated when the operator pushes the switch into the ON position, giving off light. The flow of electricity is broken when the switch is pushed into the OFF position, thus turning off the light.

4—Reflector A plastic part, coated with a shiny aluminum layer that rests around the lamp and redirects the light rays from the lamp to allow a steady or flashing light beam, which is the light the operator sees emitting from the electronic connector.

5—Lamp The light source in a connector. In most embodiments, the lamp is a light emitting diode (solid state bulb), also known as an LED. The LED contains a very small semiconductor (diode) that is encapsulated in epoxy and this part emits light when electricity flows through it.

6—Lens The lens is the clear, plastic part the operator sees on the front of the electronic connector that protects the lamp, since the lamp is made of plastic and can easily be broken. The lens may come in various shapes and sizes, including a sub-cylindrical section within the connection cylinder component(s).

7—Batteries When activated, the batteries are the power source for the electronic connectors. The batteries may be contained in the housing or within the electronic nozzle system. We expect the hose-to-device connectors of this invention to be used for other purposes, including spigot-to-hose, hose-to-hose, and hose-to-attachments such as a shut-off-valve.

When the switch of the nozzle is pushed into the ON position, if connected, it makes contact between two contact strips, which begin a flow of electricity, powered from the battery. The batteries are connected in such a way that electricity (flow of electrons) runs between the positive and negative electrodes of the battery. The batteries rest atop a small spring that is connected to a contact strip. The contact strip runs down the length of the battery case and makes contact with one side of the switch. There is another flat contact strip on the other side of the switch, which runs to the lamp, providing an electrical connection. There is another part connected to the lamp that makes contact with the positive electrode of the top battery, thus completing the circuit to the lamp and completing the generation of electricity. When the connector is decoupled, the circuitry disconnection is detected in the logic module, and the operational status is displayed as being disconnected.

When activated by electricity, the tungsten filament or LED in the lamp begins to glow, producing light that is visible. This light reflects off of the reflector that is positioned around the lamp. The reflector redirects the light rays from the lamp, creating a steady beam of light, which is the light the operator sees emitting from the connector. A clear lens covers the lamp on the electronic connector so that the lamp does not get broken or watered.

When the switch is then pushed into the OFF position, the two contact strips are physically moved apart and the path for the electrical current is broken, thus ending the production of light, and turning the connector off.

All of the above parts must be connected and in place in order for the portable connector to display the connected state.

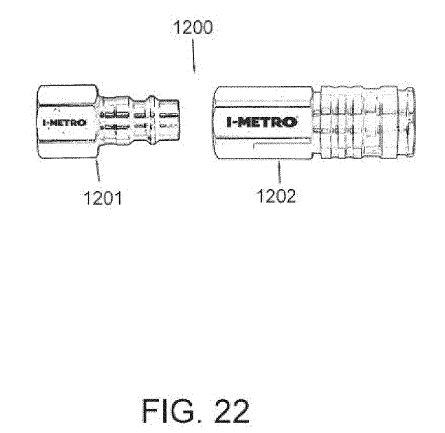

FIGS. 21A and 21B are block diagrams representing electronic quick connect/disconnect systems configured to perform the techniques disclosed herein, in accordance with an embodiment. FIG. 21 represents all electronic quick connect/disconnect systems for handheld sprayer nozzles. FIG. 22 represents all electronic quick connect/disconnect systems for sprinklers, mini-sprinklers, oscillators, and drip emitters.

FIG. 22 is a generalized side view diagram of FIGS. 21A and 21B, in accordance with an embodiment of the disclosure. The electronic quick connect/disconnect system 1200 is composed of the male assembly 1201 and female assembly 1202.

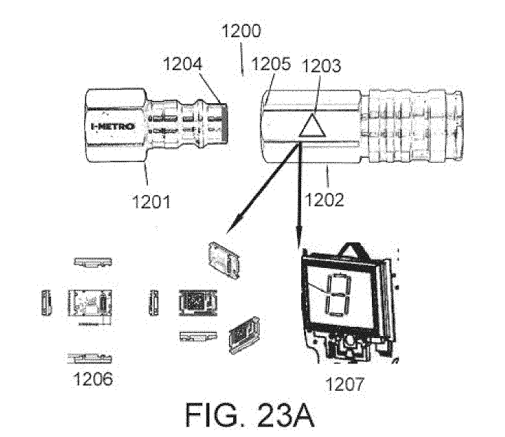

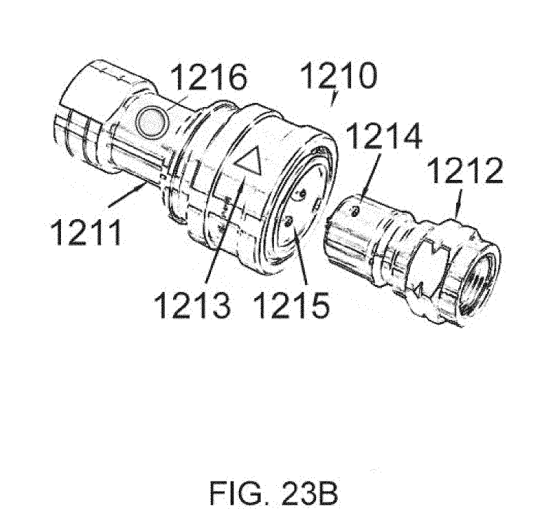

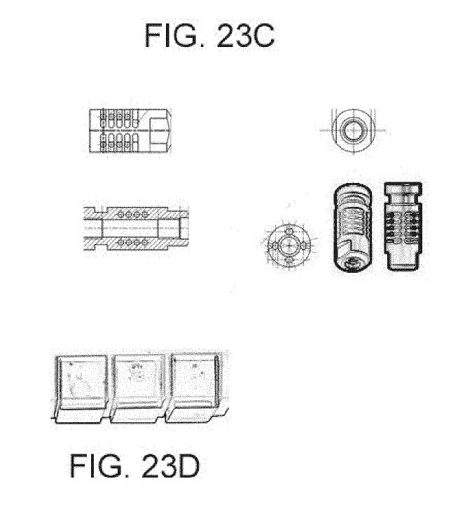

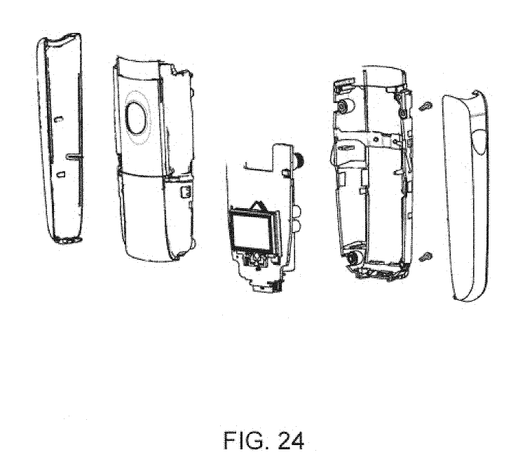

FIG. 23A is a side view illustrating the quick connect/disconnect system, in accordance with various embodiments of the disclosure. The electronic quick connect/disconnect system 1200 is composed of the male assembly 1201 and female assembly 1202. The male assembly contains an electrical contact 1204 and the female assembly contains an electrical contact 1205 (now shown, but housing within the female connector's inner housing). When connected, the contacts close an electrical loop for which the microcontroller of the nozzle (or the connector itself) instructs the light emitting diodes to illuminate in a certain color (e.g. green). When disconnected, the light emitting diodes illuminate in another color (e.g. red). If an additional circuit is provided to the system that can indicate partial connection via leads in the female and on the male, the light emitting diodes flash either green or yellow to inform the operator that the connectors are partially connected. The display interface 1203 are multi-color light emitting diodes 1206 or a LCD/OLED interface 1207. Not shown are additional controls, such as power on/off (for switching the display interface on or off).

FIG. 23B is an exploded view of the electronic quick connect/disconnect system, in accordance with various embodiments of the disclosure. The display interface 1213 are multi-color light emitting diodes which is housed within the female connector 1211. The power on/off switch (for switching the display interface on or off) 1216 is also housed on the assembly 1211. Electrical contacts 1215 and 1214 close the circuit when the quick connect system is connected.

FIG. 23C are several generalized views (cross-sectional view, side views, perspective views) of the electronic connect/disconnect system. It is important to note that the electrical connect/disconnect system can be retrofitted into existing connect/disconnect systems or manufactured entirely.

FIG. 23D is a perspective view of one LED system for the electronic quick connect/disconnect system, where each box contains an LED that indicates the current state of the connection (connected, partially connected, disconnected).

### Various Forms and Styles of First Preferred Embodiment

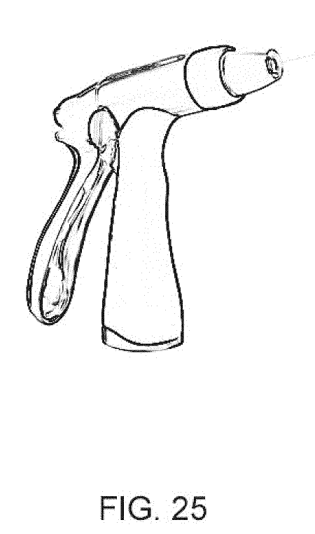

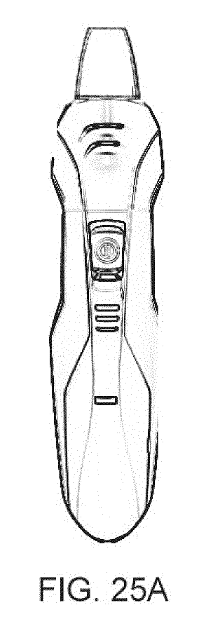

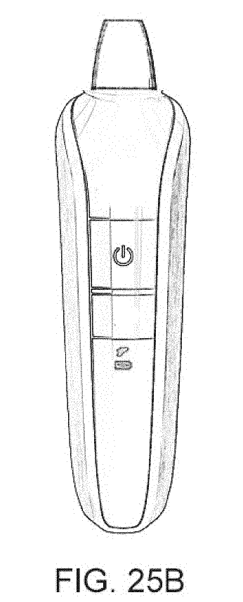

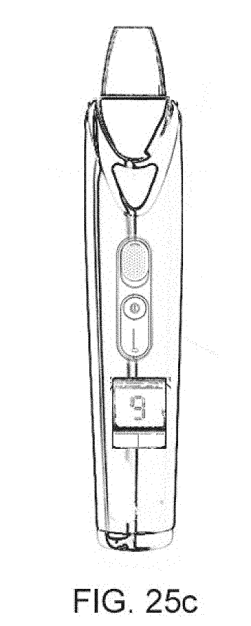

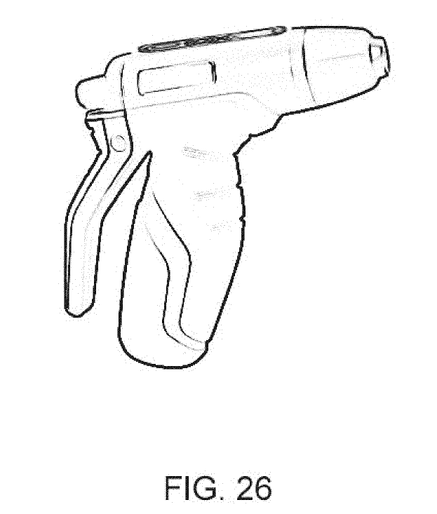

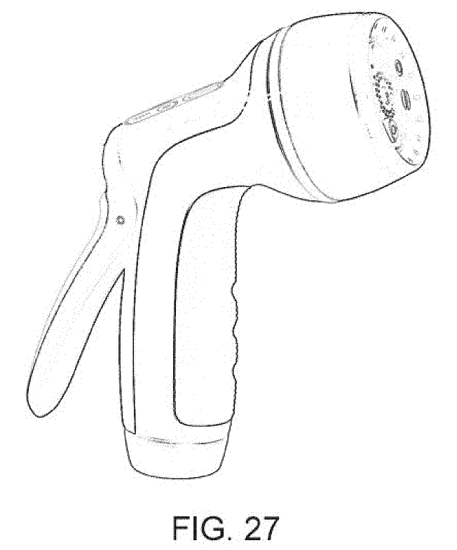

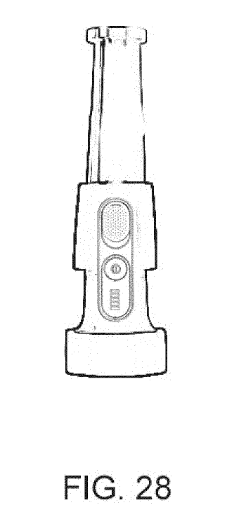

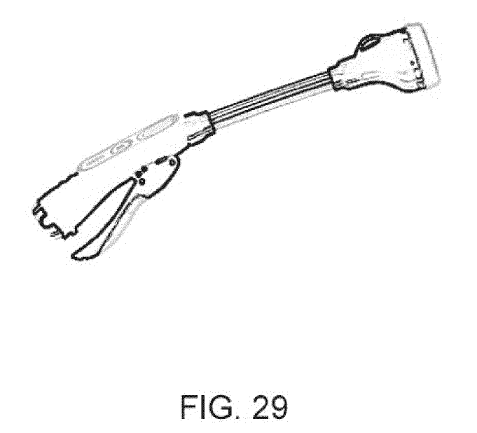

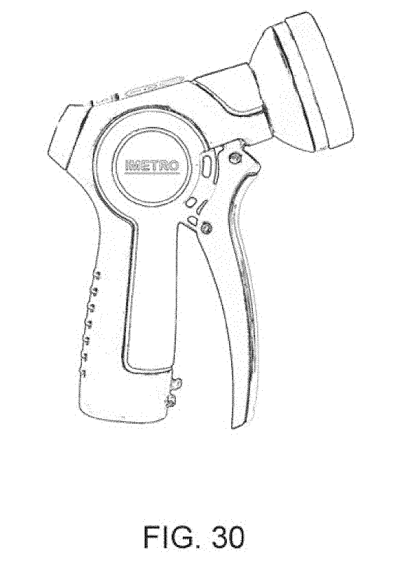

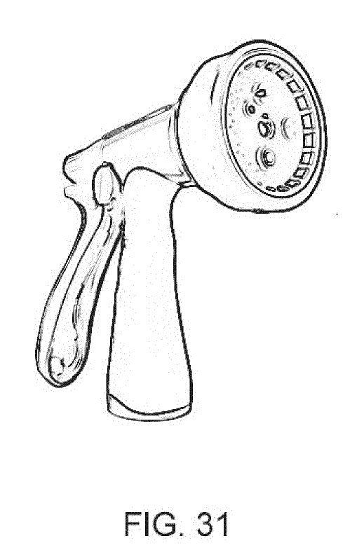

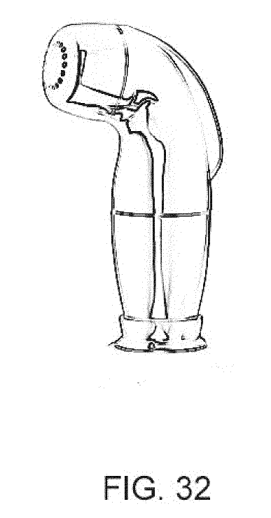

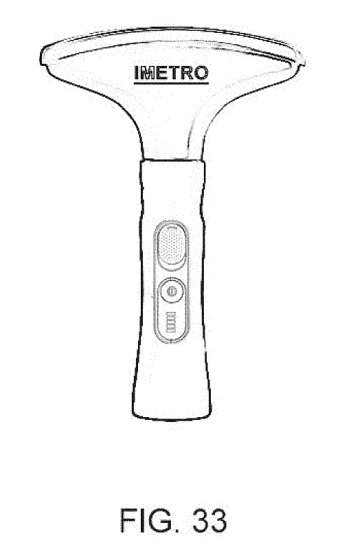

FIGS. 24 to 33 are shown only for the purpose of illustrating different embodiments of electronic-based spray nozzles. The invention is capable of other embodiments for the spray nozzle. These nozzles can replace existing conventional spray nozzles or existing non-electronic (all prior art) can be adapted using components of the present invention. What is interesting to note is illustrated in FIGS. 25A to 25C. FIGS. 25A to 25C are electronic nozzles with multi-nozzle ends which can do everything that spray gun nozzles, fan nozzles, twist nozzles can do in a new modern sleek design versus conventional gun-shaped or barrel-shaped handle forms of today. In these modern styled embodiments, they come with adjustable simple adjustment and locking mechanisms for precise watering and easy handling. These embodiments support extra wide heads to narrow nozzle ends and require gripping only the sides of the handle or gripping around the handle body. With respect to adjust and lock mechanism, the operator simply adjusts the nozzle and saves the configuration at the click of a button. For consistent output patterns and flows even in tough conditions, one embodiment may include dual battery system keeps things going. In another embodiment, the multi nozzle unit adapts to any voltage between 100V and 240V—hence the nozzle can be used anywhere in the world—that is, in any country. What is interesting to observe is that new functionality of sprayer nozzles can be supported using these new forms that are easier for users to handle, configure, and operate and it only begins here—the inventor views this as just a beginning for new watering uses for residential and commercial applications. For example, FIG. 25C demonstrates that the adjustable nozzle can be a miniature nozzle (i.e. a smaller scale version of the outdoor nozzle) for indoor use, such as watering plants, cleaning sinks, and other indoor watering applications.

### Various Forms and Styles of Second Preferred Embodiment

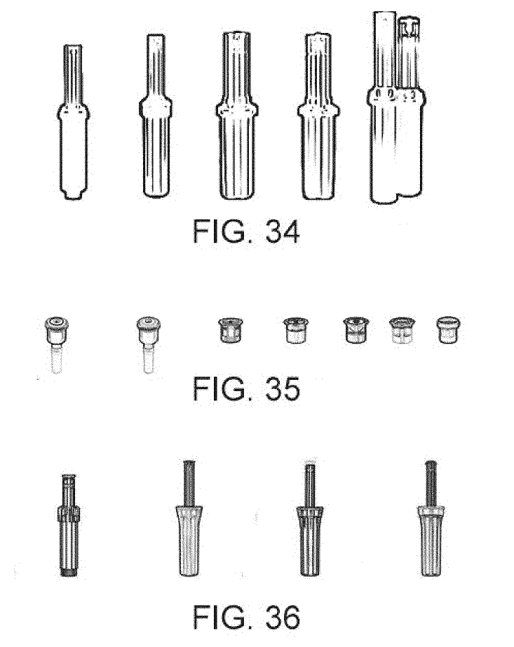

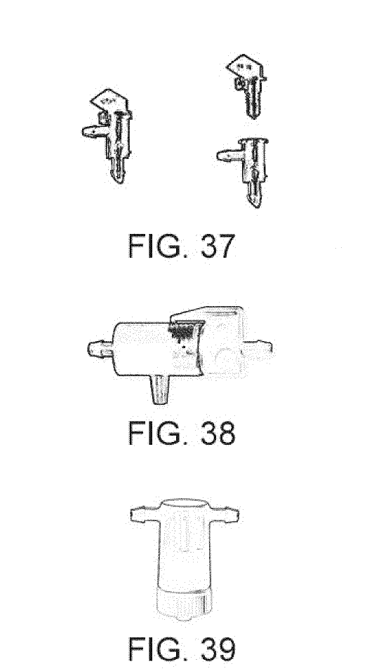

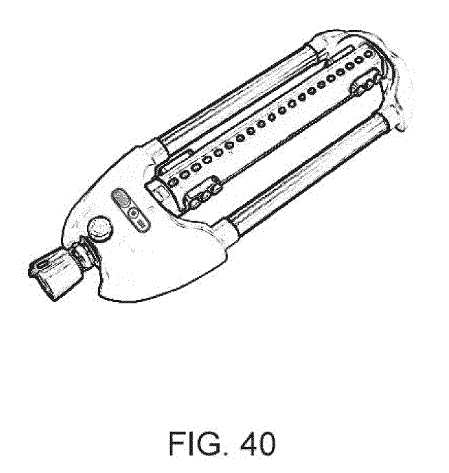

FIGS. 34 to 39 are shown for the purpose of illustrating different embodiments of electronic-based sprinkler, oscillator, and drip emitter nozzles. The invention is capable of other embodiments for the sprinkler, oscillator, and drip emitter nozzle. These nozzles can replace existing conventional irrigation nozzles or adapt to existing irrigation nozzles using components of this present invention.

### Detailed Description of the Embodiments

### Handheld Case with Built-in Charger

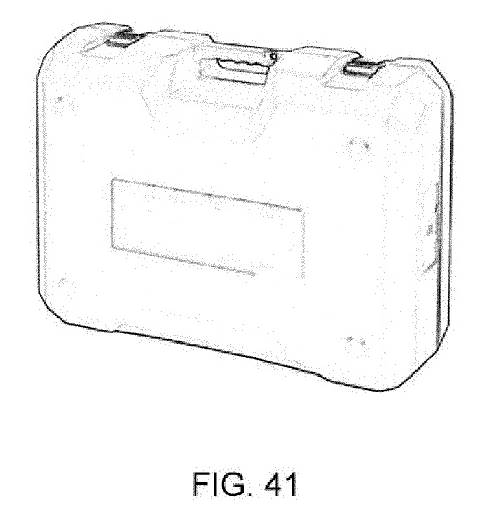

FIG. 41 is shown for the purpose of illustrating the electronic nozzle case with built-in charging unit. The case includes a built-in charger that can plug into the electronic nozzle from the interior of the housing and plug into a live outlet from the exterior of the case. The invention is capable of other embodiments of the hand-held nozzle case with built-in charging unit.

### Detailed Description of the Embodiments

### Method of Electronic Adjustment

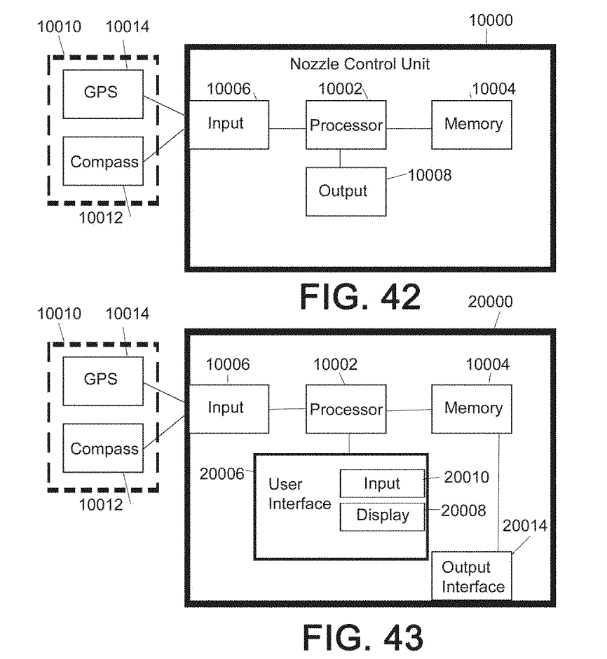

Referring to FIG. 42, a block diagram is shown illustrating an electronic control unit 10000 in accordance with one embodiment. The control unit 10000 includes a processor 10002 coupled to a memory 10004, at least one input 10006 and an output 10008. In some embodiments, the processor 10002 and the memory 10004 may be referred to collectively as a microcontroller. A GPS sensor 10014 and a compass sensor 10012 are coupled to the at least one input 10006 in order to provide signaling that corresponds to sensed or measured values. In some embodiments, the GPS sensor 10014 and the compass sensor 10012 are integrated into a combination GPS and compass sensor 10010. In some embodiments, the input 10006 also provides a user interface to allow a user to interact with the control unit 10010, e.g., to program, configure or adjust setup parameters, etc. In some embodiments, the input 10006 also functions as a power connection that provides operational power to one or both of the sensors 10010 and 10012. Furthermore, in some embodiments, the input 10006 may also function as an output allowing for bidirectional communication between the processor 10002 and the sensors 10012 and 10014. The output 10008 may be any output to provide messages to change settings. It is noted that in accordance with preferred embodiments, the GPS sensor 10014 is a sensor that provides a measurement of the location and the compass sensor 10012 is a sensor that provides both direction and directional rotation of a nozzle.

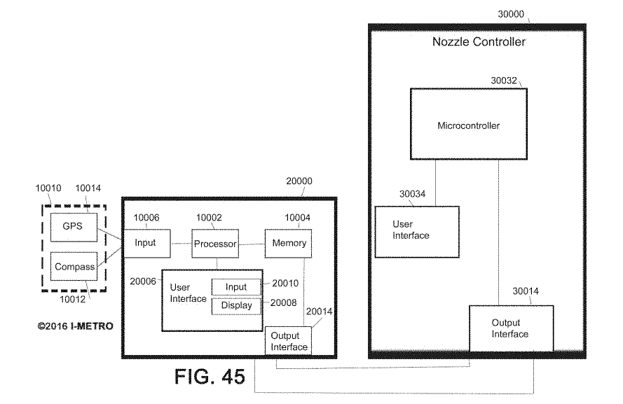

According to several embodiments, the control unit 10000 comprises a programmable controller that controls operation/adjustment to one or more sets of nozzles (or station), where each station comprises a control device. In other embodiments, the control unit 10000 is a control device that is coupled to a programmable controller (for example, see FIG. 45). In many embodiments, the control unit 10000 is adapted to automatically receive sensed location and direction data, automatically determine if adjustments/operation should occur and if so, automatically generate and/or adjust or interrupt operation.

The processor 10002 uses this input to select which set of stored values will be used in determining operation/adjustment requirements. In some embodiments, the values are pre-stored during manufacture and/or prior to sale of the control unit. In other embodiments, the values are entered by the user via the input 10006, which is helpful in cases where values are not known.

Depending on the embodiment, the determined operation/adjustment requirements may be used in a variety of ways. In some embodiments, the operation/adjustment requirement is used at least in part to automatically determine if adjustment/operation should occur during the calculation. Once it is determined that adjustment or operation should occur or be allowed, in one embodiment, the operation/adjustment requirement is used at least in part to operate or adjust for one or more stations controlling the nozzle. Typically, each station includes a flow control adjustment device that controls the type of flow of water therethrough to one or more sprinkler or watering devices. The operation/adjustment may be as simple as defining a start sprinkler arc and an end sprinkler arc for each station.

Referring next to FIG. 43, a block diagram is shown of one embodiment of the control unit of FIG. 42. In this embodiment, a control unit 20000 includes the processor 10002, the memory 10004 (which in this embodiment, are collectively as a microcontroller 20002), a user interface 10006 including a display 10008 and user inputs 20010, a sensor input interface 10012 and an output interface 20014, all generally contained within or integrated with a housing. Also illustrated are sensor 10014 and the sensor 10012.

In this embodiment, the control unit 20000 comprises a programmable controller including functionality in accordance with several embodiments for determining operation/adjustment requirements and creating, adjusting or limiting operation/adjustment based on a combination of current and stored settings. That is, in one embodiment, a user interacts with the user interface 20006 to configure the control unit to allow it to automatically determine operation/adjustment requirements and generate operational/adjustment physical settings to be executed by the processor 10002. In other embodiments, the user inputs, programs or creates one or more programs stored in the memory 10004 and executed by the processor 10002. In a typical controller, the processor 10002 outputs signaling to the output interface 20014 to cause actuation signals (e.g., AC voltage signals or DC pulse signals) to be applied to one or more of the lines out. When an actuation signal is applied to a given line, the corresponding control device is actuated to adjust or allow or stop watering. For example, the output interface 20014 includes drivers and switches that selectively switch a 24 volt AC power signal to one or more of the lines 20018. Additionally, the sensor input interface 20012 provides a coupling point for one or more sensors, such as the sensors described above. Signaling received at the sensor input interface 10012 is sent to the microcontroller 20002 for storage and processing. In other embodiments, the output interface 20014 may be an encoder output to a multi-wire path (e.g., a two-wire path) including multiple decoder devices.

The user interface 20006 includes user inputs 20010 and the display 20008. The user inputs include, for example, one or more of a keypad, a touchpad, a touchscreen, a mouse, a dial, a switch, a button, a lever, or gear-stick or other types of devices used to input information into the control unit 20000. The display 20008 includes one or more of a display screen, indicator lights (e.g., LEDs), and audible indicators or other types of display devices. The user interface 20006 is used to program and operate the control unit 20000. According to some embodiments, during the initial setup or at a later time, the user inputs a variety of information, including, for example, location of the control unit 20000 and direction of the nozzle, or other settings variables used in creating or adjusting the nozzles. In some forms, the location of the control unit 20000 is entered by inputting a code, a map code, and longitudinal and/or latitudinal coordinate for the location of the nozzle. In several embodiments, the processor 10002 uses this location information to select a given set of values stored in the memory 10004.

In some embodiments, the user interface 20006 is used to enter data values for one or more of the settings variables used to determine the adjustment or operation requirements. This data may be used to replace or supplement any data already stored in the memory. In some embodiments where data is unknown for the sub controller during manufacture, the user interface allows the user to enter data specific to the setting. In some embodiments, no data values are pre-stored prior to sale because it is known beforehand that the control unit will be sold for use in conjunction with current data (for example, the location of a sprinkler or direction of the nozzle is unknown beforehand until the sprinkler is installed).

In several embodiments, the sensor input 10012 receives signals from the GPS sensor 10010 and the direction sensor 10012 and forwards this information to the processor 10002 and/or the memory 10004. These signals correspond to current values for the amount of GPS and direction at the specific location of the control unit and/or the controller used to determine operation/adjustment requirements. In one or more embodiments, the signals received at the sensor input 10012 are electrical signals representing the current direction and current location. For example, a signal having a certain voltage level corresponds to a given GPS location identifier or direction of nozzle. Additionally or alternatively, in some embodiments, the presence of a signal at the sensor input 10012 corresponds to a given value. For example, the signal may be a pulse signal, each pulse corresponding to a certain incremental value of a variable. In other embodiments, the signals received at the sensor input 10012 are data signals defining one or more values corresponding to the current location and/or current direction. In each case, the signals received at the sensor input 10012 correspond to a current value of a given variable.

The sensor input 10012 is adapted to receive signals in a variety of ways, e.g., by wireline, fiber optic cable, and wireless communication. In some embodiments, the sensor input 10012 is a power and data interface, delivering power (e.g., AC or DC power) to the sensors 10012 and 10014 and allowing bi-directional communications. One or both of the location sensor 10014 and the direction sensor 10012 are local sensors in that they are located at or proximate to the location of the nozzle. Alternatively, one or both of the sensors 10014 and 10012 are remote sensors in that they are located at a distance from the location. In some embodiments, the current values are broadcast by wireline and/or wirelessly and received at the sensor input 10012. In some embodiments (not illustrated), sensors 10010 and 10012 are integrated into the housing of the control unit 20000. In an alternative embodiment, the current values are input by the user, for example, via the user interface 20006. For example, the user may simply enter the current value for one or more settings variables. That is, in the appropriate menu option, the user enters the current values known to the user other than by using a sensor coupled to the control unit 20000.

In other embodiments, the user does not program a control setting as is normally understood. Instead, the user simply programs the processor 10002 (via the user interface 10006) to define certain watering patterns and flows. Similarly, the user may instead program watering flows, patterns, arcs, radius, and so forth. The processor 10002 automatically determines operation/adjustment requirements based on the current values of location and direction values of one or more other settings variables as described above.

Once the operation/adjustment requirements are determined, the processor 10002 determines whether or not the nozzle requires adjustments at all. If it is determined that adjustment and/or operation is required, the processor 10002 then determines the adjustments or operation that will provide the determined operation/adjustment requirement. For example, if the operation/adjustment requirements result in that 25 degree of arc adjustment should be applied by the control unit 20000, then the processor 10002 determines (given current adjustment settings, etc.) the delta adjustment of the nozzle adjustments. The processor 10002 then outputs signaling to the output interface 20014 to cause adjustment for the specified changes/requirements. In this embodiment, the overall adjustment is automatically calculated based on the operation/adjustment requirements. In either case, these embodiments allow for the efficient use of time of the user since the processor can calculate the overall adjustments needing to be made to the nozzle, i.e. sprinkler head nozzle.

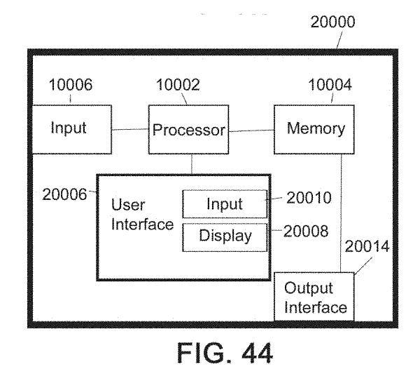

Referring next to FIG. 44, a block diagram is shown of another embodiment of the control unit of FIG. 42. In this embodiment, the control unit 10000 includes the processor 10002, the memory 10004 (which in this embodiment, are collectively as a microcontroller), a user interface 20006 including a display 20008 and user inputs 20010 and an output interface 20014, all generally contained within or integrated with a housing. In this embodiment, the user enters input as to what settings the nozzle should adjust to and the processor sends messages on behalf of those user-entered adjustments. This is the simplest form of control—that is, no sensors are involved. This may control nozzles such as spray nozzles, pattern nozzles, and the like.

Referring next to FIG. 45, a block diagram is shown of another embodiment of the control unit of FIG. 42. In this embodiment, a control unit 10000 is separate from (non-integrated with) a programmable controller 30000 on the sprinkler. The control unit 10000 includes the processor 10002, the memory 10004 (which in this embodiment, are collectively a microcontroller), a user interface 20006 including a display 20008 and user inputs 20010, a sensor input 10014 and an output interface 10012, all generally contained within or integrated with a housing. The controller 30000 includes a microcontroller 30032, a user interface 30034, and an output interface 30014 all generally contained within or integrated with a housing. Also illustrated is the GPS sensor 10014 and nozzle direction sensor 10012 coupled to the sensor input 10010, one or more lines 2018 each coupling the output interface 210014 to a nozzle control device (e.g., a gear-driven rotor adjuster) and a line 20022.

In this embodiment, the control unit 10000 is a control device that is coupled to the programmable controller 30000. As is well known, the controller 30030 adjusts or operates based on programmed values for adjustments and operation. For example, a user interacts with the user interface 30034 to set or program one or more adjustments stored in and executed by the microcontroller 30032. In one example, for each control device 20000 (i.e. a station), the microcontroller 30032 is programmed to adjust or operate as set by the user. As described above, when the adjustment/operations indicate that changes should occur for a given control device 20000, the output interface 20014 switches an activation signal on a given line to the given control device 20000 causing adjustments to be made to one or more sprinkler devices.

Similar to the embodiments described above, the control unit 20000 includes stored values of settings variables in the memory 10004 (e.g., either pre-stored during manufacture, prior to sale or entered by the user) used at least in part to determine operation/adjustment requirements. Additionally, the control unit 20000 receives signals from the GPS sensor 114 and the direction sensor 10012 at the sensor input 10012 that correspond to current values including the location and direction used at least in part to determine operation/adjustment requirements. The processor 10002 automatically determines the operation/adjustment requirements such as described above. In different embodiments, the processor 10002 uses the determined operation/adjustment requirements in different ways.

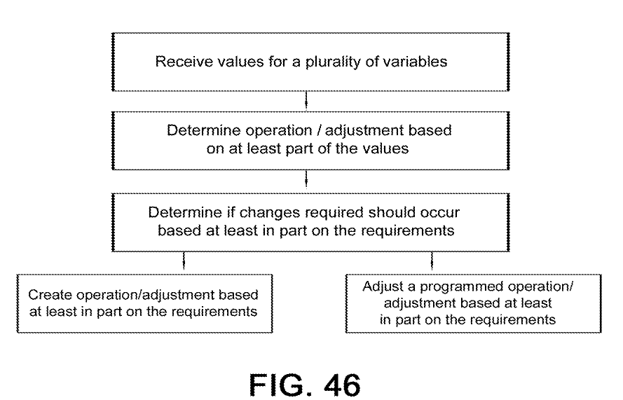

Referring next to FIG. 46, a flow chart illustrates a method of determining operation/adjustment requirements using one or more user entered values of one or more settings variables together with one or more current values of one or more other settings variables from one or more sensors in accordance with several embodiments. For example, in some embodiments where a control unit may be operated, data for settings variables used to determine operation/adjustment requirements is unknown. In other embodiments, the stored data for settings variables specific to a particular sub-controller may not necessarily be accurate for the particular location by the control unit. In such cases, and other cases, a user is allowed to enter values for one or more settings variables that are stored in the control unit as values for the one or more settings variables. In such embodiments, the user interface of the control unit, e.g., user interfaces 20006 and 30034, allow the user to enter such information. For example, the appropriate menu displays are generated based on user manipulation of one or more controls (such as rotary dials, buttons, etc.).

Next, the user entered values are stored in memory, e.g., memory 10004. The user entered values may be added to the memory in addition to other manufacturer pre-stored values that are stored in memory prior to the control unit being sold. Alternatively, the user entered values may replace a set of manufacturer pre-stored values. Thus, in some embodiments, the memory of the control unit contains pre-stored values for one or more of the settings variables that will be used by the control unit. These pre-stored values are supplemented or replaced by the user entered values. In some cases, the memory contains pre-stored values for some of the settings variables but does not pre-store values for others of the settings variables. In some cases, the memory contains no pre-stored values for settings variables. In other cases, the memory stores pre-stored (before the sale of the control unit) values of one or more settings variables but does not store pre-stored values of one or more other settings variables.

Next, current values of one or more other settings variables are received from one or more sensors coupled to the control unit, the current values corresponding to the location and direction. The one or more other settings variables are different from the one or more settings variables for which user entered values have been received. In preferred embodiments, the one or more other settings variables may include any of the settings variables described throughout this specification as being useful at least in part in determining operation/adjustment requirements. For example, in preferred embodiments, the one or more other settings variables include location and direction. In this case, current values of a sensed location and a sensed direction are received via an input of the control unit from a location sensor and a direction sensor or combination. In some embodiments, the current value/s are the primary source of values for the one or more other settings variables, not a backup source. For example, the current values are not used as a backup in the event current values from a remote or other source are not available.

Next, the current values are stored in memory, e.g., memory 10004, in addition to the user entered values and/or any other values pre-stored in memory prior to the control unit being sold.

Once the values are stored, in some embodiments, the control unit will begin manual operation where it will use data from memory. Thus, in operation, one or more of the values are received (or retrieved) from memory. Again, in preferred embodiments, the stored user entered values are the primary source, not a backup source of values for the one or more settings variables.

Next, operation/adjustment requirements are determined based at least in part on the one or more of the user entered values and the one or more of the current values of the one or more other settings variables, if current values are to be used. This determination may be made according to any of the methods described herein.

Generally, it is noted that the method of FIG. 46 may be implemented by one or more components of an electronic control unit. For example, under control and direction of a processor (e.g., processor 10002), the method of FIG. 46 is performed. Additional components are provided, such as a user interface, memory and sensor input. For a user's perspective, in some embodiments, the user obtains or is provided with a control unit that is configured and manufactured to determine operation/adjustment requirements based at least in part on values of a plurality of settings variables.

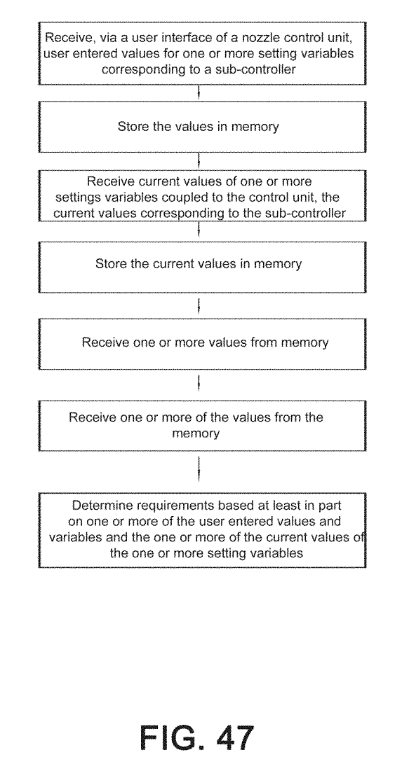

Referring next to FIG. 47, a flowchart is shown that illustrates a method of automatically determining operation/adjustment requirements in accordance with several embodiments. These steps may be performed, for example, by the control units described herein, such as control units 10000, 20000 and 30000. Generally, in order to make efficient use of adjustments and operations in the nozzle in accordance with several embodiments, operation/adjustment requirements are determined based at least in part on a number of settings variables which are used to create and/or modify the adjustments and operation. Sensors are provided to output currently sensed values of GPS and compass settings used to determine operation/adjustment requirements. In some embodiments, the pre-stored data is stored or loaded into the control unit at installation, for example downloaded or transferred from an external memory device into the memory of the control unit (e.g., via a computer or other connection of the user interface). In other embodiments, the stored data is entered by the user, for example via the user interface. Such embodiments would allow the user to enter data. In some embodiments, the data is pre-stored during manufacture, but can be replaced or supplemented with data entered by the user via the user interface.

Furthermore, other settings variables or configuration data may have already been entered by a user. The user inputs may pertain to location of nozzle, direction of nozzle, geographical maps or other factors that may affect adjustments/operation. In preferred form, the location information includes a longitudinal or latitudinal coordinate, and/or elevation information, to define the location. In some embodiments, the user inputs other reference points so the controller can determine the current location and direction of nozzle. In some embodiments, the operation/adjustment requirements discussed below are adjusted by one or more factors, such as some of the user entered settings variables.

Initially, current values of the amount of GPS and direction of the nozzle are received. For example, these values are received at the processor 10002 directly from the input 10006 (from the GPS sensor 10014 and the compass sensor 10012) or from the memory 10004 (in the event the current values from the input 10006 are buffered in or temporarily stored in memory 10004). It is noted that in several embodiments, values for one or more of GPS and direction are not stored in the memory. Next, values for a plurality of settings variables needed to determine operation/adjustment requirements are received. For example, these values are received at the processor 10002 from the memory 10004. For example, in several embodiments, the processor 10002 retrieves values stored in memory 10004 (e.g., pre-stored during manufacture or prior to sale or entered by the user). In some embodiments, no values are stored for direction and location.

Next, operation/adjustment requirements are determined at least in part using the current values of location and direction and the values for one or more other settings variables.

The control unit is also configured and manufactured to receive current values of a first set of one or more of the plurality of settings variables, the current values corresponding to a particular sub-controller.

While a number of examples have been described for illustration purposes, the foregoing description is not intended to limit the scope of the invention, which is defined by the scope of the appended claims. There are and will be other examples and modifications within the scope of the following claims.

While we have described and illustrated in detail several embodiments of an electronic nozzle system, it should be understood that our invention can be modified in both arrangement and detail. For example electronic nozzle components can be placed in any position required to operate and adjust the nozzle. There may be secondary adapters not mentioned. There may be more or fewer adjustment controls in the secondary adapters in order to control specific manufacturer products. The adaptor kit for the nozzle could be integrally molded into the nozzle turret of a manufacturer. The adapter kit could be integrally molded into its own stand-alone body. Therefore, the term “electronic nozzle” as used herein includes any subset of components that adjust and operate any port, orifice or other opening that forms and/or ejects a stream of fluid, regardless of whether the nozzle is incorporated into a removable generally tubular structure such as those illustrated herein in the forms detailed. Additionally, the extender or riser assemblies or other supporting attachment members could be used as a fixed riser or extender without the outer housing or even included within the main housing. It is not necessary for the electromechanical mechanisms to be gear driven. The controls could be formed on the nozzle turrets instead of the secondary nozzle embodiment. Therefore the protection afforded our invention should not be limited with respect to the physical boundaries of components as described herein.

It is understood that this invention is not limited to the details of construction and arrangement of parts and components illustrated in the accompanying drawings. The invention is capable of other embodiments. Further, the phraseology and terminology employed herein are for purposes of description and not of limitation.

1-55. (canceled)

56. An electronic nozzle, comprising:
a body having
an inlet end,
an outlet end,
a body chamber defining a first portion of a fluid flow channel and extending through the interior of the body from the inlet end to the outlet end,
an inlet connector disposed within the inlet end, wherein the inlet connector is configured to connect to a fluid source, and
an outlet connector disposed within the outlet end;
a nozzle head, the nozzle head being removably attached to the outlet connector of the body, the nozzle head comprising
a nozzle head inlet end,
a nozzle head outlet end, wherein a discharge orifice is formed within the nozzle head outlet end, and
a nozzle head chamber defining a second portion of the fluid flow channel and extending through the interior of the nozzle head from the nozzle head inlet end to the nozzle head outlet end;
one or more adjustable components configured to adjust a characteristic of a fluid stream discharged through the discharge orifice;
one or more electric motors configured to adjust the one or more adjustable components responsive to control signals;
a controller configured to provide the control signals; and
electronic circuitry in electrical communication with the one or more electric motors and the controller.

57. The electronic nozzle of claim 56, further comprising:
a memory configured to store preset configuration information for a plurality of different types of the nozzle head;
wherein, responsive to the attachment of the nozzle head to the body, the controller is further configured to
detect the type of the nozzle head, and
adjust and operate the nozzle head in accordance with the preset configuration information for the type of the nozzle head.

58. The electronic nozzle of claim 57, further comprising:
a user interface, wherein a user may employ the user interface to override the preset configuration information.

59. The electronic nozzle of claim 56, wherein the adjustable component adjusts at least one of:
a volume of the fluid stream;
a pattern of the fluid stream;
a flow rate of the fluid stream;
an angle of the fluid stream;
a radius of the fluid stream;
a frequency of the fluid stream;
a distance of throw of the fluid stream;
a range of the fluid stream;
a flow opening of the fluid stream;
a nozzle tip location; and
a direction of flow of the fluid stream.

60. The electronic nozzle of claim 56, wherein the adjustable component comprises at least one of:
a solenoid valve;
a non-solenoid valve;
a pattern disk;
a shaft;
a coupling;
a key;
a turret;
a spline;
a bearing;
a gear;
a sprocket;
a mechanical fastener;
a screw;
a nut;
a ring;
a pin;
a clip;
a belt;
a clutch;
a chain;
a brake;
a seal;
a ferrule; and
a gripping device.

61. The electronic nozzle of claim 56, further comprising:
a power source configured to provide power to the electric motor and the controller.

62. The electronic nozzle of claim 61, wherein the power source comprises:
at least one battery.

63. The electronic nozzle of claim 62, wherein the power source comprises a housing configured to secure the at least one battery.

64. The electronic nozzle of claim 62, wherein:
the at least one battery is rechargeable.

65. The electronic nozzle of claim 64, further comprising:
at least one solar panel configured to recharge the rechargeable battery.

66. The electronic nozzle of claim 56, further comprising:
an electromechanical framework comprising
a plurality of latches configured to mechanically secure a plurality of removable electronic modules within the electronic nozzle, and
a plurality of electronic connectors configured to electronically connect the removable electronic modules to the electronic circuitry of the electronic nozzle.

67. The electronic nozzle of claim 66, further comprising:
one or more of the removable electronic modules.

68. The electronic nozzle of claim 67, wherein the one or more of the removable electronic modules comprise at least one of:
the controller module;
a memory module;
a display module;
a wireless communications module;
a wired communications module;
a global positioning system module;
a compass module;
a gyroscope module;
a speaker module;
a power source module;
a display module;
a user-operable control module;
an antenna module;
a global positioning system receiver module;
a LCD comprising a screen and lens module;
a core controller module comprising a removable CPU, GPU, ROM, RAM;
a storage module;
an amplifier module;
an audio module;
a driver module;
a clock & timer module;
a programmable logic circuit;
a visual module;
a tactile module;
a solar module;
a photovoltaic module;
a power management module;
a sensor module;
a USB module; and
a micro-USB module.

69. The electronic nozzle of claim 56, further comprising:
at least one sensor.

70. The electronic nozzle of claim 69, wherein the at least one sensor is selected from the group consisting of:
an RFID tag;
a proximity sensor;
a location sensor;
a direction sensor;
a pressure sensor;
a temperature sensor;
an optical sensor;
a capacitive sensor;
an inductive sensor;
a resistive sensor;
an acoustic sensor;
a flow sensor;
an audio sensor;
an optical sensor;
a force sensor;
a capacitive touch sensor;
a linear displacement sensor;
a current sensor;
a liquid level sensor;
a magnetic sensor;
an environmental sensor; and
a motion sensor.

71. The electronic nozzle of claim 56, further comprising:
an electronic display interface having at least one electronic display device in communication with the controller.

72. The electronic nozzle of claim 56, further comprising:
an electronic control interface having at least one user-operable actuator in communication with the controller, wherein the controller operates in accordance with operation of the user-operable actuators.

73. The electronic nozzle of claim 72, wherein:
responsive to operation of one of the actuators the controller causes one or more of the display devices to display at least one of
a message, and
a luminous status indicator.

74. The electronic nozzle of claim 73, wherein the luminous status indicator comprises at least one of:
an LED;
a bar graph;
a circle graph;
a monitor;
an LCD;
an OLED;
a plasma display; and
a touch display.

75. The electronic nozzle of claim 56, wherein:
at least one of the inlet connector and the outlet connector forms a first end of a quick connector, having a coupling end and an attachment end adapted to be connected in fluid flow relationship to the fluid flow channel.

76. The electronic nozzle of claim 75, further comprising:
a display device in communication with the controller;
wherein the quick connector is in communication with the controller; and
wherein the controller is configured to cause the display device to indicate a connection status of the quick connector.

77. The electronic nozzle of claim 76, wherein the first end of the quick connector comprises:
an electronic indicator configured to indicate a connection status of the quick connector.

78. The electronic nozzle of claim 76, further comprising:
a second end of the quick connector, the second end having a coupling end and an attachment end adapted to be connected in fluid flow relationship to the fluid flow channel; and
a locking mechanism associated with the first connector and the second connector to secure the coupling end of the first connector in the receiving opening of the coupling end of the second connector when the coupling end of the first connector is inserted into and fully received in coupling condition in the receiving opening and to release the coupling end of the first connector from the receiving opening when desired to disconnect the first connector from the second connector.

79. The electronic nozzle of claim 78, wherein:
the first end of the quick connector comprises a first electrical contact;
the second end of the quick connector comprises a second electrical contact; and
at least one of the first end of the quick connector and the second end of the quick connector comprises an indicator configured to indicate a connection status of the quick connector.

80. The electronic nozzle of claim 56, further comprising:
a wireless communications module in communication with the controller.

81. The electronic nozzle of claim 56, further comprising:
a wired communications module in communication with the controller.

82. The electronic nozzle according to claim 56, wherein the controller limits the volume through which the fluid can be brought into and exited out of the fluid flow channel contained within the body.

83. The electronic nozzle of claim 56, further comprising:
a drive assembly coupled to a drive shaft of one of the electric motors and configured to convert movement of the drive shaft into movements of at least one of the adjustable components of the electronic nozzle.

84. The electronic nozzle according to claim 83, further comprising:
an intermediate gearing interposed between the electric motor and the drive shaft.

85. The electronic nozzle according to claim 83, wherein the drive assembly comprises:
a coupler having a first end, a second end, and an intermediate component connected to a drive shaft;
wherein the first end of the coupler is operably coupled to a nozzle head and the intermediate component is rotationally received within the second end of the coupler;
rotation of the drive shaft causes the intermediate component to rotate within the second end; and
rotation of the intermediate component causes the coupler to change the behavior of the dispersion of fluid.

86. The electronic nozzle according to claim 56, wherein:
at least one of the adjustable components is disposed within the nozzle head.

87. The electronic nozzle according to claim 56, wherein the nozzle head comprises at least one of:
one or more of the electric motors;
one or more user-operable actuators; and
one or more display devices.

88. The electronic nozzle according to claim 56, further comprising:
one or more user-operable mechanical actuators configured to control a mechanically operated component of the electronic nozzle.

89. The electronic nozzle according to claim 88, wherein the one or more user-operable mechanical actuators comprise at least one of:
a knob;
a slider;
a button;
a trigger;
a lever;
a gear-stick;
a handle;
a switch;
a ring;
a dial; and
a turret.

90. The electronic nozzle according to claim 56, wherein the body further comprises:
a product source connector configured to connect to a separate source of product, wherein the product is passed to the fluid flow channel.

91. The electronic nozzle according to claim 90, wherein the product source connector comprises:
a first connector having a coupling end and an attachment end adapted to be connected in fluid flow relationship to the fluid flow line;
a second connector having a coupling end with a receiving opening to receive the coupling end of the first connector therein and an attachment end adapted to be connected in fluid flow relationship to the fluid flow line; and
a locking mechanism associated with the first connector and the second connector to secure the coupling end of the first connector in the receiving opening of the coupling end of the second connector when the coupling end of the first connector is inserted into and fully received in coupling condition in the receiving opening and to release the coupling end of the first connector from the receiving opening when desired to disconnect the first connector from the second connector.

92. The electronic nozzle according to claim 91, wherein the body further comprises:
a valve configured to move along the fluid flow channel among a first position of the valve relative to the body where the valve resides within the fluid flow channel between the inlet end and the outlet end, a second position of the valve relative to the body where the valve opens the fluid flow channel between the inlet end and the outlet end, and a third position of the valve relative to the body where the valve opens the fluid flow channel between the inlet end and the outlet end and communicates the fluid flow channel with the product source connector and with the separate source of product when the separate source of product is connected to the product source connector.

93. The electronic nozzle according to claim 91, wherein the product source connector is an electronic connector, that can indicate a connection status using one or more electronic indicators, and wherein the electronic connector further comprises:
an electronic indicator on the first connector and the second connector cooperating to indicate when the connectors are in coupling condition, as the connectors are joined and moved into coupling condition, and as the connectors are released and separated from coupling condition;
electronic circuitry on the first and second connectors in electronic communication with the controller;
one or more electronic indicators disposed within the second connector;
wherein the controller is further configured to generate a message responsive to the current connection state of the first connector in relation to the second connector; and
each electronic indicator is configured to provide the message responsive to the controller generating the message.

94. The electronic nozzle according to claim 56, further comprising a luminous component comprising:
a housing;
a cover;
one or more luminous elements; and
electronic circuitry getting power from the power module of the electronic nozzle and in electrical communication with each luminous element and the electronic circuitry of the electronic nozzle.

95. The electronic nozzle according to claim 94, wherein the one or more luminous elements are selected from the group consisting of:
a tungsten filament;
a LED bulb;
a LED module; and
a laser.

96. The electronic nozzle according to claim 56, further comprising:
an auto shut-off timer module having an adjustable time-out period and configured to detect the current period of inactivity and signal to the controller when the adjustable time-out period has been detected;
wherein the controller is further configured to power off the electronic nozzle or put the electronic nozzle into standby mode, responsive to the time-out period signal produced by the auto shut-off timer.

97. The electronic nozzle according to claim 56, wherein:
at least one of the body and/or nozzle head components are marketplace products offered by other brands and manufacturers, but further configured to support electronic nozzle functionality as described in the present disclosure;
the electronic nozzle is provided as an adaption kit that adapts to the marketplace products, such that a user at least partially disassembles the previously assembled nozzle system, then installs at least one adaption component of the adaption kit in the at least partially disassembled nozzle system, and then finally re-assembles the nozzle system with at least one adaption component from the adaption kit installed therein; and
the adaption kit can adjust the adjustable components of the marketplace nozzle.

98. The electronic nozzle according to claim 97, wherein the adjustable components of the marketplace nozzle comprise at least one of:
a horizontal arc adjustment screw;
a speed control adjustment screw;
a water flow adjustment screw.
a radius adjustment screw;
a rotation adjustment dial;
a x, y, z adjustment mechanical screw; and
a water flow adjustment screw.

99. The electronic nozzle of claim 56, further comprising:
an electronic container for fluids, such that the container or cartridge is removably connected to the electronic nozzle, the electronic container comprising
electronic circuitry in electrical communication with the electronic circuitry of the electronic nozzle, and
at least one electronic display device;
wherein the controller is further configured to generate a message responsive to a fluid level of the electronic container; and
wherein the at least one electronic display device is configured to provide a message responsive to the controller generating the message.

100. The electronic nozzle of claim 56, wherein the body further comprises:
a check valve, wherein the controller is further configured to control the check valve.

101. The electronic nozzle of claim 56, wherein the body further comprises:
a pressure regulator, wherein the controller is further configured to control the pressure regulator.

102. The electronic nozzle of claim 56, where the one or more motors comprise at least one of:
a linear motor;
a rotary motor;
a three-dimensional rotary motor; and
an electromagnetic motor.

103. The electronic nozzle according to claim 56, where the nozzle head is connected via a pivoted connector to the outlet connector.

104. A handheld nozzle comprising:
the electronic nozzle according to claim 1; and
a handle attached to the body.

105. The handheld nozzle of claim 104, wherein is selected from the group consisting of:
a pistol nozzle;
a pattern nozzle;
a rear-trigger pattern nozzle;
a super nozzle;
a jet nozzle;
a high velocity nozzle;
a propelling nozzle;
a soaker nozzle;
a rotating nozzle;
an adjustable nozzle;
a fireman nozzle;
a wand nozzle;
an articulating watering pattern wand nozzle;
an industrial twist nozzle;
a sweeper nozzle;
a fan nozzle with flow control and shutoff;
a gutter cleaner nozzle; and
a cylindrical nozzle.

106. The handheld nozzle of claim 104, further comprising:
an extender attachment.

107. A sprinkler comprising the electronic nozzle of claim 1.

108. The sprinkler of claim 107, wherein the sprinkler is selected from the group consisting of:
a fixed spray sprinkler;
a bubbler sprinkler;
a gear-drive sprinkler, wherein the nozzle head rotates in relation to the body;
a rotor sprinkler;
an adjustable gear-drive sprinkler, wherein the nozzle head pops up and pops down;
a ball-drive sprinkler;
an oscillating sprinkler;
a multiple-stream sprinkler;
a simple pop-up sprinkler;
an adjustable pattern pop-up sprinkler;
a pulse pop-up impact and gear stream nozzle sprinkler; and
an angle-adjuster sprinkler.

109. The electronic nozzle of claim 107, further comprising:
a riser attachment.

110. A shower head comprising the electronic nozzle of claim 1.

111. The shower head of claim 110, wherein the shower head is selected from the group consisting of:
a pattern shower head nozzle;
an adjustable rainshower nozzle; and
a shower head wand nozzle.

112. A mounted nozzle comprising:
the electronic nozzle according to claim 56; and
at least one of:
a mounting seat; and
a mounting bottom plate.

113. The electronic nozzle of claim 56, where the electronic nozzle is selected from the group consisting of:
a micro sprinkler; a drip emitter; a drip tubing nozzle; a micro sprayer nozzle; a micro adjustable spray jet; a micro spray jet; a micro pop-up sprayer; a micro fan spray jet; a drip emitter; an electronic pistol nozzle; an electronic pattern nozzle; an electronic rear-trigger pattern nozzle; an electronic super nozzle; an electronic jet nozzle; an electronic high velocity nozzle; an electronic propelling nozzle; an electronic soaker nozzle; an electronic rotating nozzle; an electronic adjustable nozzle; an electronic fireman nozzle; an electronic wand nozzle; an electronic articulating watering pattern wand nozzle; an electronic industrial twist nozzle; an electronic sweeper nozzle; an electronic fan nozzle with flow control and shutoff; an electronic gutter cleaner nozzle; an electronic cylindrical nozzle; an electronic fixed spray sprinkler; an electronic bubbler sprinkler; an electronic gear-drive sprinkler, wherein the nozzle rotates in relation to the body; an electronic rotor sprinkler; an electronic adjustable gear-drive sprinkler, wherein the nozzle pops up and pops down; an electronic ball-drive sprinkler; an electronic oscillating sprinkler; an electronic multiple-stream sprinkler; an electronic simple pop-up sprinkler; an electronic adjustable pattern pop-up sprinkler; an electronic pulse pop-up impact and gear stream nozzle sprinkler; an electronic angle-adjuster sprinkler; an electronic micro sprinkler; an electronic adjustable drip emitter; an electronic drip tubing nozzle; an electronic micro sprayer nozzle; an electronic adjustable micro spray jet; an electronic micro spray jet; an electronic micro pop-up sprayer; an electronic micro fan spray jet; an electronic micro jet sprayer; an electronic drip emitter; an electronic pattern shower nozzle; an electronic adjustable rainshower nozzle; an electronic shower wand nozzle; an electronic single-handle sprayer nozzle; an electronic pull-down faucet nozzle; an electronic pull-out faucet nozzle; an electronic spigot nozzle; an electronic sillcock nozzle; and an electronic bibb nozzle.

114. A faucet comprising the electronic nozzle of claim 56.

115. The faucet of claim 114, wherein the faucet is selected from the group consisting of:
an adjustable faucet;
a single-handle sprayer faucet;
a pull-down faucet;
a pull-out faucet;
a spigot;
a sillcock; and
a bibb.

116. The electronic nozzle of claim 56, further comprising:
a recharge station configured to recharge the power source of the electronic nozzle.

117. The electronic nozzle of claim 56, further comprising at least one of:
one or more power cords;
one or more battery holders;
one or more clips;
one or more electronic contacts;
one or more power management circuits;
one or more AC power entry modules;
one or more DC power connectors;
one or more power supplies;
one or more AC power plugs;
one or more AC power receptacles;
one or more AC/DC converters;
one or more batteries;
one or more transformers;
one or more battery chargers; and
one or more power inverters.

118. The electronic nozzle of claim 116, further comprising:
a case, wherein the case comprises the recharge station configured to recharge the power source of the electronic nozzle while the electronic nozzle is stored in the case.

119. The electronic nozzle of claim 118, further comprising:
a cleaner;
a lubricator; and
a processor, wherein the processor is configured to
control the recharge station to recharge of the power source,
control the cleaner to clean the nozzle, and
control the lubricator to lubricate the nozzle.

120. The electronic nozzle of claim 56, further comprising:
one or more accessories attachable to the electronic nozzle.

121. The electronic nozzle of claim 120, wherein the one or more accessories comprise:
one or more variable adjusters configurable by users to create unique watering patterns.

122. The electronic nozzle of claim 56, further comprising:
a flow-thru connector that can directly connect the electronic nozzle to two attachment hoses at the same time, one for inlet of fluid and another for product to be mixed with fluid, using only the primary inlet container.

123. The electronic nozzle of claim 56, further comprising:
at least one non-electronic nozzle head configured to be removably attached to the outlet connector of the body.

124. The electronic nozzle of claim 123, wherein the at least one non-electronic nozzle head is selected from the group consisting of:
an adjustable sprayer head; an adjustable sprinkler head; an adjustable oscillator head; an adjustable drip emitter head; an adjustable nozzle tip; an adjustable fan head; an adjustable pattern head; an pistol nozzle head; an pattern nozzle head; an rear-trigger pattern nozzle head; an super nozzle head; an jet nozzle head; an high velocity nozzle head; an propelling nozzle head; an soaker nozzle head; an rotating nozzle head; an adjustable nozzle head; an fireman nozzle head; an wand nozzle head; an articulating watering pattern wand nozzle head; an industrial twist nozzle head; an sweeper nozzle head; an fan nozzle head with flow control and shutoff; an gutter cleaner nozzle head; an cylindrical nozzle head; an fixed spray sprinkler head; an bubbler sprinkler head; an gear-drive sprinkler, wherein the nozzle head rotates in relation to the body head; an rotor sprinkler head; an adjustable gear-drive sprinkler head, wherein the nozzle head pops up and pops down head; an ball-drive sprinkler head; an oscillating sprinkler head; an multiple-stream sprinkler head; an simple pop-up sprinkler head; an adjustable pattern pop-up sprinkler head; an pulse pop-up impact and gear stream nozzle sprinkler; an angle-adjuster sprinkler head; an micro sprinkler head; an adjustable drip emitter head; an drip tubing nozzle head; an micro sprayer nozzle head; an adjustable micro spray jet head; an micro spray jet head; an micro pop-up sprayer head; an micro fan spray jet head; an micro jet sprayer head; an drip emitter head; an pattern shower head nozzle head; an adjustable rainshower nozzle head; an shower head wand nozzle head; an single-handle sprayer nozzle head; an pull-down faucet nozzle head; an pull-out faucet nozzle head; an spigot nozzle head; an sillcock nozzle head; and an bibb nozzle head.

125. The electronic nozzle of claim 56, further comprising:
at least one electronic nozzle head configured to be removably attached to the outlet connector of the body.

126. The electronic nozzle of claim 125, wherein the at least one electronic nozzle head is selected from the group consisting of:
an electronic adjustable sprayer head; an electronic adjustable sprinkler head; an electronic adjustable oscillator head; an electronic adjustable drip emitter head; an electronic adjustable nozzle tip; an electronic adjustable fan head; an electronic adjustable pattern head; an electronic micro-spray attachment; an electronic micro-tubing attachment; an electronic drip nozzle attachment; an electronic pistol nozzle head; an electronic pattern nozzle head; an electronic rear-trigger pattern nozzle head; an electronic super nozzle head; an electronic jet nozzle head; an electronic high velocity nozzle head; an electronic propelling nozzle head; an electronic soaker nozzle head; an electronic rotating nozzle head; an electronic adjustable nozzle head; an electronic fireman nozzle head; an electronic wand nozzle head; an electronic articulating watering pattern wand nozzle head; an electronic industrial twist nozzle head; an electronic sweeper nozzle head; an electronic fan nozzle head with flow control and shutoff; an electronic gutter cleaner nozzle head; an electronic cylindrical nozzle head; an electronic fixed spray sprinkler head; an electronic bubbler sprinkler head; an electronic gear-drive sprinkler, wherein the nozzle head rotates in relation to the body head; an electronic rotor sprinkler head; an electronic adjustable gear-drive sprinkler head, wherein the nozzle head pops up and pops down head; an electronic ball-drive sprinkler head; an electronic oscillating sprinkler head; an electronic multiple-stream sprinkler head; an electronic simple pop-up sprinkler head; an electronic adjustable pattern pop-up sprinkler head; an electronic pulse pop-up impact and gear stream nozzle sprinkler; an electronic angle-adjuster sprinkler head; an electronic micro sprinkler head; an electronic adjustable drip emitter head; an electronic drip tubing nozzle head; an electronic micro sprayer nozzle head; an electronic adjustable micro spray jet head; an electronic micro spray jet head; an electronic micro pop-up sprayer head; an electronic micro fan spray jet head; an electronic micro jet sprayer head; an electronic drip emitter head; an electronic pattern shower head nozzle head; an electronic adjustable rainshower nozzle head; an electronic shower head wand nozzle head; an electronic single-handle sprayer nozzle head; an electronic pull-down faucet nozzle head; an electronic pull-out faucet nozzle head; an electronic spigot nozzle head; an electronic sillcock nozzle head; and an electronic bibb nozzle head.

127. An electronic nozzle, comprising:
body means for defining a first portion of a fluid flow channel and extending through the body means from an inlet end of the body means to an outlet end of the body means, wherein the body means comprises
inlet means for connecting to a fluid source, wherein the inlet connector means is disposed within the inlet end, and
outlet means for connecting, wherein the outlet connector means is disposed within the outlet end;
nozzle head means for defining a second portion of the fluid flow channel extending through the interior of the nozzle head means from a nozzle head inlet end to a nozzle head outlet end, wherein nozzle head means is removably attached to the outlet connector of the body means, and wherein a discharge orifice is formed within the outlet end of the nozzle head means, and
one or more means for adjusting a characteristic of a fluid stream discharged through the discharge orifice;
one or more motor means for adjusting the one or more means for adjusting components responsive to control signals;
controller means for providing the control signals; and
electronic means for connecting the one or more motor means and the controller means.

128. An electromechanical sprinkler adjuster, comprising:
a body;
a connector configured to connect the body to a sprinkler, wherein the sprinkler has at least one adjuster, wherein each adjuster is operable to adjust a corresponding adjustable component of the sprinkler, and wherein each adjustable component adjusts a characteristic of a fluid stream discharged by the sprinkler;
one or more electric motors disposed within the body, wherein each of the electric motors is coupled to a corresponding drive shaft, and wherein each drive shaft operably mates with one of the adjusters in the sprinkler responsive to the body being connected to the sprinkler;
a controller configured to provide motor control signals; and
electronic circuitry in electrical communication with the one or more electric motors and the controller;
wherein responsive to the motor control signals at least one of the electric motors drives a corresponding drive shaft, wherein a corresponding adjuster in the sprinkler is adjusted responsive to the driving of the corresponding drive shaft, wherein a corresponding adjustable component of the sprinkler is adjusted responsive to the adjustment of the corresponding adjuster, and wherein a corresponding characteristic of the fluid stream discharged by the sprinkler is adjusted responsive to the adjustment of the corresponding adjustable component of the sprinkler.

129. The electromechanical sprinkler adjuster of claim 128, wherein:
at least one of the adjusters in the sprinkler is a rotary adjuster; and
a corresponding one of the motors is a rotary motor.

130. The electromechanical sprinkler adjuster of claim 128, wherein:
at least one of the adjusters in the sprinkler is a linear adjuster; and
a corresponding one of the motors is a linear motor.

131. The electromechanical sprinkler adjuster of claim 128, wherein:
the connector is configured to temporarily connect the body to the sprinkler.

132. The electromechanical sprinkler adjuster of claim 128, wherein:
the connector is configured to permanently connect the body to the sprinkler.
